(19) United States
(12) Patent Application Publication
(10) Pub. No.: US 2022/0244726 A1
(43) Pub. Date: Aug. 4, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: OSAMU SHIGETA, TOKYO (JP)

(21) Appl. No.: 17/597,128

(22) PCT Filed: May 20, 2020
(86) PCT No.: PCT/JP2020/020485

§ 371 Date: Dec. 27, 2021

(30) Foreign Application Priority Data
Jul. 3, 2019 (JP) 2019-124738

(51) Int. Cl. G05D 1/00; H04N 7/18; H04N 5/262; H04N 5/272

(52) U.S. Cl. CPC G05D 1/0038; H04N 5/272; H04N 5/2628; H04N 7/185

(57) ABSTRACT

In an information processing apparatus (10a), a mobile body information reception unit (70) receives mobile body information including an image (Ia) (first image) captured by a camera (26) (imaging unit) mounted on a mobile robot (20a) (mobile body). Further, an operation information generation unit (75) generates operation information including movement control information for instructing the mobile robot (20a) to move on the basis of an input to an operation input unit (79). An operation information transmission unit (76) transmits the operation information including the movement control information to the mobile robot (20a). Then, an image generation unit (73a) generates an image (Ib) (second image) corresponding to the movement of the mobile robot (20a) indicated by the movement control information from the image (Ia) on the basis of the movement control information received by the mobile body information reception unit (70).

### FIELD

The present disclosure relates to an information processing apparatus, an information processing method, and a program.

### BACKGROUND

In the future, with the spread of ultra-high-speed and ultra-low delay communication infrastructures typified by the fifth generation mobile communication system (5G), it is expected that a person performs work and communication via a robot at a remote place. For example, a person who is not at a work site maneuvers construction equipment such as a heavy machine, a conference is held by face to face (F2F) communication with a person who is at a distant position through a robot, and a person remotely participates in an exhibition at a distant place. When such a remote operation is performed, information communication based on an image is essential, but there is a possibility that operability is significantly impaired as a video of a camera installed in a robot is presented to the user with a delay. Thus, for example, in the case of a mobile robot, it collides with a person or an obstacle. Further, by being conscious of the operation in consideration of the delay, it is necessary to concentrate on the operation, which increases a psychological and physical load. It is also conceivable to predict a collision using a sensor on the robot side to automatically avoid collisions. However, in the case of a head mounted display (HMD) or a multi-display or in a case where the inside of a vehicle is entirely covered with a monitor in a self-driving vehicle, there is a possibility that a video delay leads to sickness and the operation cannot be performed for a long time.

The cause of occurrence of the delay includes various factors such as a delay mainly due to a network, an imaging delay of a camera, signal processing, codec processing, serialization and deserialization of a communication packet, a transmission delay of a network, buffering, and a display delay of a video presentation device. Then, even if there is an infrastructure of ultra-low delay communication such as 5G, it is difficult to completely eliminate the delay since the delays are comprehensively accumulated. Furthermore, in view of the entire system, the occurrence of delay due to addition of processing is also assumed. For example, there is a possibility that a delay of several frames occurs by adding processing for improving image quality. Further, in a case where the operation input of a remote operator is immediately reflected on a robot, when the robot suddenly starts moving, the surrounding people become anxious. In order to prevent this, at the time of traveling or changing the course of the robot, it is necessary to take measures such as calling attention to the surroundings for the next action using an LED, the orientation of the face of the robot, or the like, or starting to move the robot slowly instead of sudden acceleration. However, by implementing these measures, there is a possibility of causing a further delay.

In order to prevent such delay of an image, a technique of predicting a currently captured image on the basis of a history of images captured in the past has been proposed (for example, Patent Literature 1).

### CITATION LIST

### Patent Literature

Patent Literature 1: JP 2014-229157 A

### SUMMARY

### Technical Problem

In Patent Literature 1, when a robot hand moving with a periodic basic motion pattern is remotely operated, a future image is predicted from a past history, but the delay cannot be compensated in a case where a mobile robot moves aperiodically. Further, there is no guarantee that a correct delay time can be estimated when the delay time becomes long.

Therefore, the present disclosure proposes an information processing apparatus, an information processing method, and a program capable of unfailingly compensating for a delay of an image.

### Solution to Problem

To solve the problems described above, an information processing apparatus according to an embodiment of the present disclosure includes: a mobile body information reception unit configured to receive a first image captured by an imaging unit mounted on a mobile body and mobile body information including the first image; an operation information generation unit configured to generate operation information including movement control information for instructing the mobile body to move on a basis of an input to an operation input unit; an operation information transmission unit configured to transmit the operation information including the movement control information to the mobile body; and an image generation unit configured to generate a second image corresponding to movement of the mobile body indicated by the movement control information from the first image on a basis of the movement control information.

### BRIEF DESCRIPTION OF DRAWINGS

FIG. 1 is a diagram explaining a viewpoint position of an image presented to an operator.

FIG. 2 is a diagram illustrating a schematic configuration of an information processing system using the information processing apparatus of the present disclosure.

FIG. 3 is a hardware block diagram illustrating an example of a hardware configuration of the information processing apparatus according to a first embodiment.

FIG. 4 is a hardware block diagram illustrating an example of a hardware configuration of a mobile robot according to the first embodiment.

FIG. 5 is a diagram explaining a state in which an image observed by the information processing apparatus is delayed from an actual image.

FIG. 6 is a functional block diagram illustrating an example of a functional configuration of the information processing system using the information processing apparatus according to the first embodiment.

FIG. 7 is a diagram explaining a method for estimating a current position of the mobile robot.

FIG. 8 is a diagram explaining a method for generating a prediction image according to the first embodiment.

FIG. 9 is a flowchart illustrating an example of a flow of processing performed by the information processing system according to the first embodiment.

FIG. 10 is a functional block diagram illustrating an example of a functional configuration of the information processing system using the information processing apparatus according to a variation of the first embodiment.

FIG. 11 is a diagram explaining a method for generating a prediction image according to the variation of the first embodiment.

FIG. 12 is an explanatory diagram of a spherical screen.

FIG. 13 is a diagram explaining a method for generating a prediction image according to a second embodiment.

FIG. 14 is a first diagram explaining another method for generating the prediction image according to the second embodiment.

FIG. 15 is a second diagram explaining another method for generating the prediction image according to the second embodiment.

FIG. 16 is a diagram illustrating a display example of a prediction image according to a third embodiment.

FIG. 17 is a diagram explaining a camera installation position of a mobile robot.

FIG. 18 is a diagram explaining an outline of a fourth embodiment.

FIG. 19 is a diagram explaining an outline of a fifth embodiment.

FIG. 20 is a diagram explaining an outline of a sixth embodiment.

FIG. 21 is a diagram explaining an outline of a seventh embodiment.

FIG. 22 is a diagram explaining an outline of an eighth embodiment.

### DESCRIPTION OF EMBODIMENTS

The embodiments of the present disclosure will be described below in detail on the basis of the drawings. Note that, in each embodiment described below, the same parts are designated by the same reference numerals, and duplicate description will be omitted.

Further, the present disclosure will be described in the order described below.

1. Viewpoint position of image presented to operator

2. First embodiment

2-1. System configuration of information processing system

2-2. Hardware configuration of information processing apparatus

2-3. Hardware configuration of mobile robot

2-4. Description of image delay

2-5. Functional configuration of information processing system

2-6. Method for estimating current position of mobile robot

2-7. Method for generating prediction image

2-8. Flow of processing of first embodiment

2-9. Effect of first embodiment

2-10. Variation of first embodiment

2-11. Functional configuration of variation of first embodiment

2-12. Method for generating prediction image

2-13. Effect of variation of first embodiment

3. Second embodiment

3-1. Outline of information processing apparatus

3-2. Functional configuration of information processing apparatus

3-3. Method for generating prediction image

3-4. Other method for generating prediction image

3-5. Effect of second embodiment

4. Third embodiment

4-1. Outline of information processing apparatus

4-2. Functional configuration of information processing apparatus

4-3. Effect of third embodiment

5. Notes at the time of system construction

5-1. Installation position of camera

5-2. Presence of unpredictable object

6. Description of specific application example of information processing apparatus

6-1. Description of fourth embodiment to which the present disclosure is applied

6-2. Description of fifth embodiment to which the present disclosure is applied

6-3. Description of sixth embodiment to which the present disclosure is applied

6-4. Description of seventh embodiment to which the present disclosure is applied

6-5. Description of eighth embodiment to which the present disclosure is applied

(1. Viewpoint Position of Image Presented to Operator)

Hereinafter, an information processing system that presents an image captured by a camera installed in a mobile robot to a remote operator (hereinafter, referred to as an operator) who operates the mobile robot from a distant place will be described.

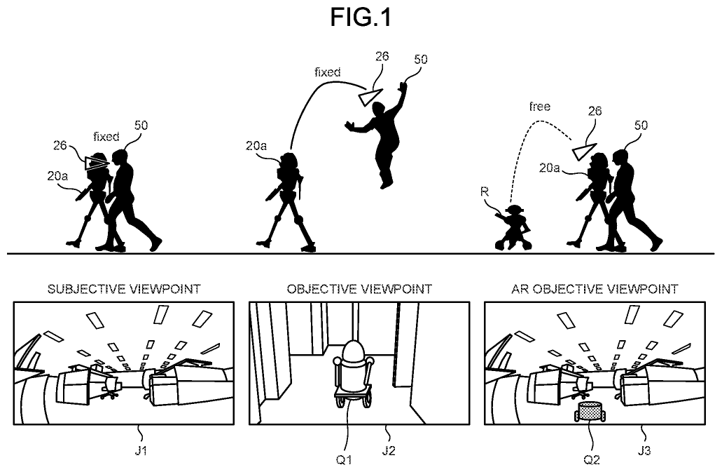

Before describing the specific system, the viewpoint position of the image presented to the operator will be described. FIG. 1 is a diagram explaining a viewpoint position of an image presented to an operator. The left column of FIG. 1 is an example in which the viewpoint position of a camera 26 installed in a mobile robot 20a substantially matches the viewpoint position of the image presented to an operator 50. That is, it is an example of giving the operator 50 an experience as if the operator 50 possesses the mobile robot 20a like the tele-existence in which the operator 50 feels as if a remote object is nearby. In this case, since the viewpoint position of an image J1 presented to the operator 50 matches the viewpoint position of the operator 50 itself, the viewpoint position is a so-called subjective viewpoint. Note that the first embodiment and the second embodiment described later cause the image J1 to be presented.

The middle column of FIG. 1 is an example in which an image observed from the camera 26 virtually installed at a position where the mobile robot 20a is looked down is presented to the operator 50. Note that an icon Q1 imitating the mobile robot 20a itself is drawn in the image. In this case, the viewpoint position of an image J2 presented to the operator 50 is a position at which the area including the mobile robot 20a is looked down, that is, a so-called objective viewpoint. Note that the first embodiment to be described later causes the image J2 to be presented.

The right column of FIG. 1 is an example in which an icon Q2 indicating a virtual robot R is presented by being superimposed on an image observed by the camera 26 installed in the mobile robot 20a. In this case, the viewpoint position of an image J3 presented to the operator 50 is a position at which the area including the mobile robot 20a is looked down, that is, a so-called augmented reality (AR) objective viewpoint. That is, the camera 26 included in the mobile robot 20a is established as a camerawork for viewing the virtual robot R. The third embodiment to be described later causes the image J3 to be presented. Note that, in the display mode of the image J3, since the icon Q2 of the virtual robot R is superimposed in the image J1 observed from the subjective viewpoint, an objective viewpoint element is incorporated in the image viewed from the subjective viewpoint. Therefore, it is an image with which the mobile robot 20a can be operated more easily as compared with the image J1.

(2. First Embodiment)

A first embodiment of the present disclosure is an example of an information processing system 5a that compensates for a video delay.

[2-1. System Configuration of Information Processing System]

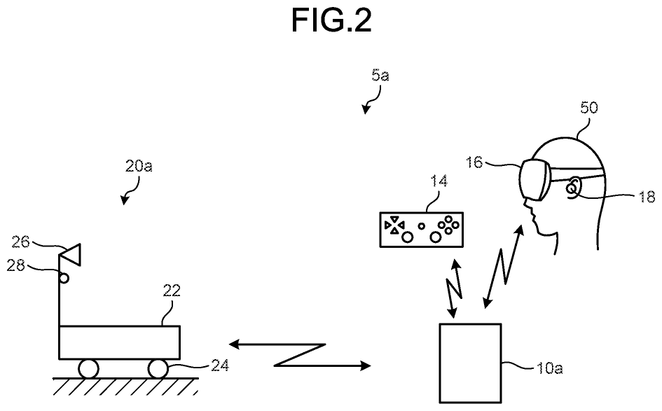

FIG. 2 is a diagram illustrating a schematic configuration of an information processing system using the information processing apparatus of the present disclosure. The information processing system 5a includes an information processing apparatus 10a and a mobile robot 20a. Note that the information processing apparatus 10a is an example of the information processing apparatus of the present disclosure.

The information processing apparatus 10a detects operation information of the operator 50 and remotely maneuvers the mobile robot 20a. Further, the information processing apparatus 10a acquires an image captured by a camera 26 included in the mobile robot 20a and a sound recorded by a microphone 28, and presents them to the operator 50. Specifically, the information processing apparatus 10a acquires operation information of the operator 50 with respect to an operation input component 14. Further, the information processing apparatus 10a causes a head mounted display (hereinafter, referred to as an HMD) 16 to display an image corresponding to the line-of-sight direction of the operator 50 on the basis of the image acquired by the mobile robot 20a. The HMD 16 is a display apparatus worn on the head of the operator 50, and is a so-called wearable computer. The HMD 16 includes a display panel (display unit) such as a liquid crystal display (LCD) or an organic light emitting diode (OLED), and displays an image output from the information processing apparatus 10a. Furthermore, the information processing apparatus 10a outputs a sound corresponding to the position of the ear of the operator 50 to an earphone 18 on the basis of the sound acquired by the mobile robot 20a.

The mobile robot 20a includes a control unit 22, a moving mechanism 24, the camera 26, and the microphone 28. The control unit 22 performs control of movement of the mobile robot 20a and control of information acquisition by the camera 26 and the microphone 28. The moving mechanism 24 moves the mobile robot 20a in an instructed direction at an instructed speed. The moving mechanism 24 is, for example, a moving mechanism that is driven by a motor 30, which is not illustrated, and has a tire, a Mecanum wheel, an omni wheel, or a leg portion such as two or more legs. Further, the mobile robot 20a may be a mechanism such as a robot arm.

The camera 26 is installed at a position above the rear portion of the mobile robot 20a, and captures an image around the mobile robot 20a. The camera 26 is, for example, a camera including a solid-state imaging element such as a complementary metal oxide semiconductor (CMOS) or a charge coupled device (CCD). Note that the camera 26 is desirably capable of capturing an omnidirectional image, but may be a camera with a limited viewing angle, or may be a plurality of cameras that observes different directions, that is, a so-called multi-camera. Note that the camera 26 is an example of the imaging unit. The microphone 28 is installed near the camera 26 and records a sound around the mobile robot 20a. The microphone 28 is desirably a stereo microphone, but may be a single microphone or a microphone array.

The mobile robot 20a is used, for example, in a narrow place where it is difficult for a person to enter, a disaster site, or the like, for monitoring the situation of the place. While moving according to the instruction acquired from the information processing apparatus 10a, the mobile robot 20a captures a surrounding image with the camera 26 and records a surrounding sound with the microphone 28.

Note that the mobile robot 20a may include a distance measuring sensor that measures a distance to a surrounding obstacle, and may take a moving route for autonomously avoiding an obstacle when the obstacle is present in a direction instructed by the operator 50.

[2-2. Hardware Configuration of Information Processing Apparatus]

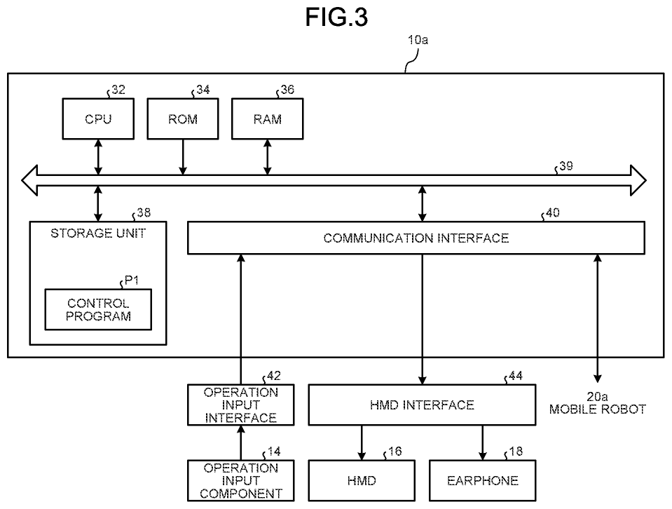

FIG. 3 is a hardware block diagram illustrating an example of a hardware configuration of the information processing apparatus according to the first embodiment. The information processing apparatus 10a has a configuration in which a central processing unit (CPU) 32, a read only memory (ROM) 34, a random access memory (RAM) 36, a storage unit 38, and a communication interface 40 are connected by an internal bus 39.

The CPU 32 controls the entire operation of the information processing apparatus 10a by loading a control program P1 stored in the storage unit 38 or the ROM 34 on the RAM 36 and executing the control program P1. That is, the information processing apparatus 10a has the configuration of a general computer that operates by the control program P1. Note that the control program P1 may be provided via a wired or wireless transmission medium such as a local area network, the Internet, or digital satellite broadcasting. Further, the information processing apparatus 10a may execute a series of processing by hardware.

The storage unit 38 includes a hard disk drive (HDD), a flash memory, or the like, and stores information such as the control program P1 executed by the CPU 32.

The communication interface 40 acquires operation information (instruction information corresponding to, for example, forward movement, backward movement, turning, speed adjustment, and the like) input to the operation input component 14 by the operator 50 via an operation input interface 42. The operation input component 14 is, for example, a game pad. Further, the communication interface 40 presents an image corresponding to the line-of-sight direction of the operator 50 to the HMD 16 and presents a sound corresponding to the position of the ear of the operator 50 to the earphone 18 via an HMD interface 44. Furthermore, the communication interface 40 communicates with the mobile robot 20a by wireless communication or wired communication, and receives an image captured by the camera 26 and a sound recorded by the microphone 28 from the mobile robot 20a.

Note that, in FIG. 3, an image may be presented using a display, a multi-display, a projector, or the like instead of the HMD 16. Further, when an image is projected using a projector, a spherical or hemispherical large screen surrounding the operator 50 may be used to give a more realistic feeling.

Further, in FIG. 3, a sound may be presented using a speaker instead of the earphone 18. Furthermore, instead of the game pad, an operation instruction mechanism having a function of detecting a gesture of the operator 50 or an operation instruction mechanism having a voice recognition function of detecting a voice of the operator 50 may be used as the operation input component 14. Alternatively, an operation instruction may be input using an input device such as a touch panel, a mouse, or a keyboard.

Further, the operation input component 14 may be an interface that designates a movement destination or a moving route on the basis of a map or the like of an environment where the mobile robot 20a is placed. That is, the mobile robot 20a may automatically move along a designated route to the destination.

Furthermore, in the present embodiment, the information processing apparatus 10a transmits movement control information (information including a moving direction and a moving amount of the mobile robot 20a, for example, information such as a speed and a direction) for practically moving the mobile robot 20a to the mobile robot 20a on the basis of the operation information input to the operation input component 14 by the operator 50, but may transmit other information. For example, parameter information for constructing a model of how much the mobile robot 20a actually moves may be transmitted to the mobile robot 20a on the basis of the operation information input to the operation input component 14 by the operator 50. Thus, for example, even in the case of a different road surface condition, it is possible to predict the position of the mobile robot 20a according to the actual road surface information.

[2-3. Hardware Configuration of Mobile Robot]

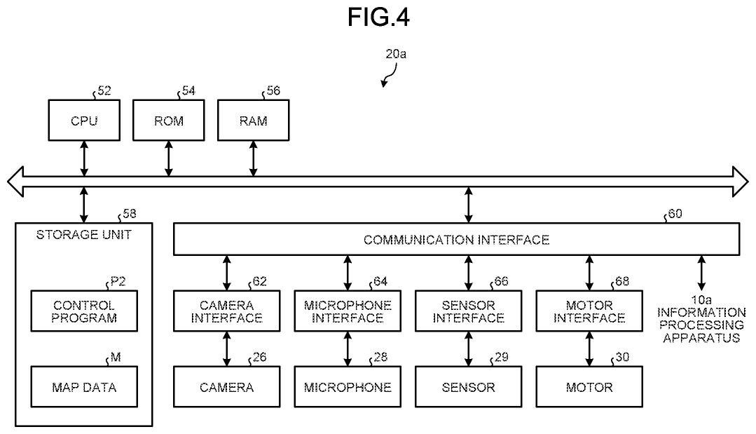

FIG. 4 is a hardware block diagram illustrating an example of a hardware configuration of a mobile robot according to the first embodiment. The mobile robot 20a has a configuration in which a CPU 52, a ROM 54, a RAM 56, a storage unit 58, and a communication interface 60 are connected by an internal bus 59.

The CPU 52 controls the entire operation of the mobile robot 20a by loading a control program P2 stored in the storage unit 58 or the ROM 54 on the RAM 56 and executing the control program P2. That is, the mobile robot 20a has the configuration of a general computer that operates by the control program P2.

The storage unit 58 includes an HDD, a flash memory, or the like, and stores information such as the control program P2 executed by the CPU 52, map data M of an environment in which the mobile robot 20a moves, or the like. Note that the map data M may be a map generated in advance, or may be a map automatically generated by the mobile robot 20a itself using a technique such as simultaneous localization and mapping (SLAM) described later. Further, the map data M may be stored in the storage unit 38 of the information processing apparatus 10a and transmitted to the mobile robot 20a as necessary, or may be stored in a server, which is not illustrated in FIG. 4, and transmitted to the mobile robot 20a as necessary.

The communication interface 60 acquires an image captured by the camera 26 via a camera interface 62. Further, the communication interface 60 acquires a sound recorded by the microphone 28 via a microphone interface 64. Furthermore, the communication interface 60 acquires sensor information obtained from various sensors 29 included in the mobile robot 20a via a sensor interface 66. Note that the various sensors 29 include a gyro sensor that measures a moving state such as a moving direction and a moving amount of the mobile robot 20a, an acceleration sensor, a wheel speed sensor, a global positioning system (GPS) receiver, and the like. The gyro sensor measures the angular velocity of the mobile robot 20a. Further, the acceleration sensor measures the acceleration of the mobile robot 20a. The wheel speed sensor measures the wheel speed of the mobile robot 20a. The GPS receiver measures the latitude and longitude of the current position of the mobile robot 20a using data received from a plurality of positioning satellites. The mobile robot 20a calculates the self-position on the basis of the outputs of these sensors. Note that the mobile robot 20a may have a distance measuring function such as a laser range finder that measures a distance to a surrounding object. Then, the mobile robot 20a may automatically generate a surrounding three-dimensional map on the basis of the distance to the surrounding object while moving itself. Thus a technique in which a moving object automatically generates a map around the moving object is called SLAM. Further, the communication interface 60 gives a control instruction to the motor 30 via a motor interface 68.

Note that the self-position calculated by the mobile robot 20a may be expressed by coordinate information in map data (MAP) created by the mobile robot 20a itself, or may be expressed by latitude and longitude information measured by the GPS receiver. Further, the self-position calculated by the mobile robot 20a may include information of the orientation of the mobile robot 20a. The information of the orientation of the mobile robot 20a is determined, for example, from output data of an encoder included in the gyro sensor mounted on the mobile robot 20a or an actuator that changes the imaging direction of the camera 26, in addition to the map data and the latitude and longitude information described above.

Note that the time generated by a timer included in the CPU 52 is set as a reference time for controlling the information processing system 5a. Then, the mobile robot 20a and the information processing apparatus 10a are time-synchronized with each other.

[2-4. Description of Image Delay]

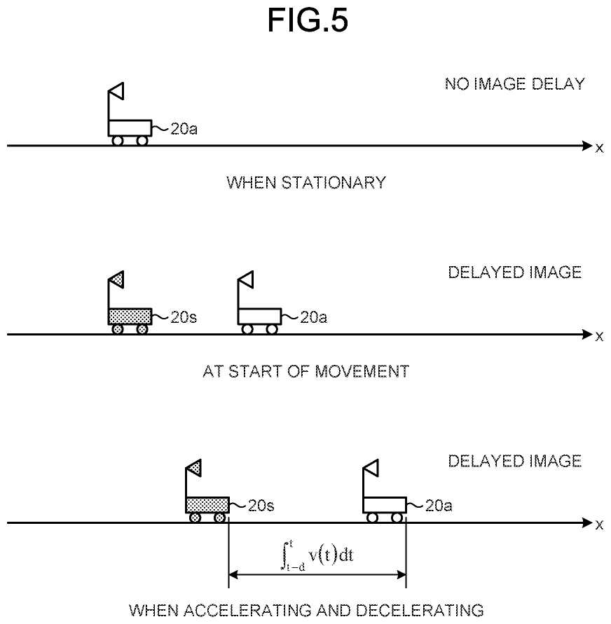

FIG. 5 is a diagram explaining a state in which an image observed by the information processing apparatus is delayed from an actual image. In particular, the upper part of FIG. 5 is a diagram illustrating a state in which the mobile robot 20a is stationary. In a case where the mobile robot 20a is stationary, when an image captured by the camera 26 is displayed on the HMD 16, because a mobile robot 20 is stationary, no delay occurs in the displayed image. That is, the currently captured image is displayed on the HMD 16.

The middle part of FIG. 5 is a diagram illustrating a state at the time of start of movement of the mobile robot 20a. That is, when the operator 50 of the information processing apparatus 10a issues an instruction to the mobile robot 20a to move forward (move along the x axis), the mobile robot 20a immediately starts to move forward in response to the instruction. At that time, the image captured by the camera 26 is transmitted to the information processing apparatus 10a and displayed on the HMD 16, but at that time, a delay of the image occurs, and thus, an image captured in the past by the delay time, for example, an image captured by a mobile robot 20s before the start of movement is displayed on the HMD 16.

The lower part of FIG. 5 is a diagram illustrating a state in which the mobile robot 20a moves while repeating acceleration and deceleration. In this case as well, as in the middle part of FIG. 5, a delay of the image occurs, and thus an image captured by the mobile robot 20s at a past position by the delay time is displayed on the HMD 16.

For example, a case where the mobile robot 20a is moving at a constant speed, for example, a speed of 1.4 m/s per second is considered. At this time, assuming that the delay time of the image is 500 ms, when an image captured at a distance to which the mobile robot 20a moves in 500 ms, that is, at a position 70 cm ahead is displayed, delay compensation when the image is displayed can be performed. That is, it is sufficient if the information processing apparatus 10a generates an image predicted to be captured at a position 70 cm ahead on the basis of the latest image captured by the camera 26 of the mobile robot 20a, and presents the image to the HMD 16.

In general, it is not possible to predict a future image, but it is possible to acquire information input to the operation input component 14 by the operator 50 of the information processing apparatus 10a, that is, operation information (moving direction, speed, and the like) instructed to the mobile robot 20a. Then, the information processing apparatus 10a can estimate the current position of the mobile robot 20a on the basis of the operation information.

Specifically, the information processing apparatus 10a integrates the moving direction and the speed instructed to the mobile robot 20a over the delay time. Then, the information processing apparatus 10a calculates the position at which the mobile robot 20a arrives when the time corresponding to the delay time has elapsed. The information processing apparatus 10a further estimates and generates an image captured from the estimated position of the camera 26.

Note that, for the sake of simple description, FIG. 5 is an example in which the mobile robot 20a is assumed to move along the x-axis direction, that is, one-dimensional movement. Therefore, as illustrated in the lower part of FIG. 5, the mobile robot 20a moves forward the distance calculated by Formula (1) during delay time d. Here, v(t) indicates the speed of the mobile robot 20a at current time t. Note that when the moving direction is not one-dimensional, that is, when the moving direction is two-dimensional or three-dimensional, it is sufficient if the same calculation is performed for each moving direction.

∫_{t-d}^{t}v(t)dt (1)

Thus, the information processing apparatus 10a can estimate the position of the camera 26 at the current time on the basis of the operation information given to the mobile robot 20a. Note that a method of generating an image captured from the estimated position of the camera 26 will be described later.

[2-5. Functional Configuration of Information Processing System]

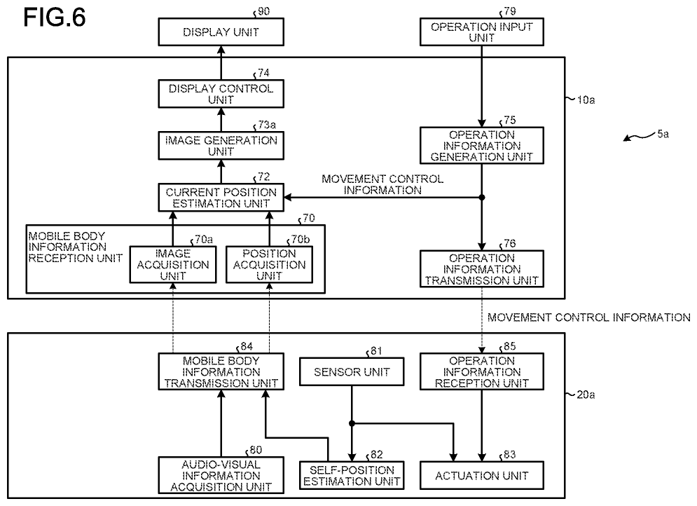

FIG. 6 is a functional block diagram illustrating an example of a functional configuration of the information processing system using the information processing apparatus according to the first embodiment. The information processing system 5a includes the information processing apparatus 10a and the mobile robot 20a. Note that the mobile robot 20a is an example of the mobile body.

The information processing apparatus 10a includes a mobile body information reception unit 70, a current position estimation unit 72, an image generation unit 73a, a display control unit 74, an operation information generation unit 75, and an operation information transmission unit 76. The information processing apparatus 10a moves the mobile robot 20a in accordance with movement control information (information including the moving direction and the moving amount of the mobile robot 20a) generated by the operation information generation unit 75 on the basis of an input to an operation input unit 79 by the operator 50. Further, the information processing apparatus 10a displays, on a display unit 90, an image (an image Ib to be described later) generated on the basis of the position information received by the information processing apparatus 10a from the mobile robot 20a, an image (an image Ia to be described later) captured by the mobile robot 20a, and the movement control information.

The mobile body information reception unit 70 receives mobile body information including the image Ia (first image) captured by the camera 26 (imaging unit) mounted on the mobile robot 20a and the position information indicating the position of the mobile robot 20a (mobile body) at time to when the image Ia is captured. The mobile body information reception unit 70 further includes an image acquisition unit 70a and a position acquisition unit 70b. Note that the position information indicating the position of the mobile robot 20a may be coordinates in map data included in the mobile robot 20a or latitude and longitude information. Further, the position information may include information of the orientation of the mobile robot 20a (the traveling direction of the mobile robot 20a or the imaging direction of the camera 26).

The image acquisition unit 70a acquires the image Ia (first image) captured by an audio-visual information acquisition unit 80 mounted on the mobile robot 20a and the time to at which the image Ia is captured.

The position acquisition unit 70b acquires a position P(tb) of the mobile robot 20a and time tb at the position P(tb) from the mobile robot 20a. Note that the position P(tb) includes the position and speed of the mobile robot 20a.

The current position estimation unit 72 estimates the current position of the mobile robot 20a at the time on the basis of the above-described mobile body information and operation information transmitted by the operation information transmission unit 76 described later. More specifically, current position P(t) of the mobile robot 20a is estimated on the basis of the position P(tb) of the mobile robot 20a acquired by the position acquisition unit 70b, the time tb at the position P(tb), and the movement control information generated by the operation information generation unit 75 from the time tb to the current time t. Note that a specific estimation method will be described later.

The image generation unit 73a generates the image Ib (second image) corresponding to the movement of the mobile robot 20a (mobile body) indicated by the movement control information from the image Ia (first image) on the basis of the position information and the movement control information received by the mobile body information reception unit 70. More specifically, the image generation unit 73a generates, from the image Ia, the image Ib corresponding to the position of the mobile robot 20a at the time to at which the image Ia is captured, on the basis of the current position P(t) of the mobile robot 20a estimated by the current position estimation unit 72 and the map data M stored in the mobile robot 20a. Further specifically, the image generation unit 73a generates the image Ib predicted to be captured from the viewpoint position of the camera 26 (imaging unit) corresponding to the current position P(t) of the mobile robot 20a.

Note that, in a case where the position information received by the mobile body information reception unit 70 includes the information of the orientation of the mobile robot 20a, the image generation unit 73a may use the information of the orientation when generating the image Ib (second image). For example, it is assumed that the imaging direction of the camera 26 is oriented laterally by 90° with respect to the traveling direction of the mobile robot 20a. In this case, when a forward command is input to the mobile robot 20a, the image generation unit 73a generates an image predicted to be captured by the camera 26 at a position where the camera 26 has virtually moved forward while maintaining the state of being oriented laterally by 90° with respect to the traveling direction.

The display control unit 74 causes the display unit 90 (display panel such as LCD or OLED) included in the HMD 16 to display the image Ib via an image output interface such as High-Definition Multimedia Interface (HDMI) (registered trademark).

The display unit 90 displays the image Ib in accordance with an instruction from the display control unit 74. The display panel included in the HMD 16 is an example of the display unit 90.

The operation input unit 79 inputs operation information with respect to the operation input component 14 by the operator 50 to the information processing apparatus 10a.

The operation information generation unit 75 generates operation information including the movement control information for instructing the mobile robot 20a to move on the basis of the input to the operation input unit 79.

The operation information transmission unit 76 transmits the operation information including the movement control information to the mobile robot 20a.

The mobile robot 20a includes the audio-visual information acquisition unit 80, a sensor unit 81, a self-position estimation unit 82, an actuation unit 83, a mobile body information transmission unit 84, and an operation information reception unit 85.

The audio-visual information acquisition unit 80 acquires the image Ia (first image) around the mobile robot 20a captured by the camera 26 of the mobile robot 20a, and a sound.

The sensor unit 81 acquires information regarding the moving direction and the moving amount of the mobile robot 20a, a distance from an object around the mobile robot 20a, and the like. Specifically, the sensor unit 81 includes a sensor such as a gyro sensor, an acceleration sensor, or a wheel speed sensor, and a distance measuring sensor such as so-called laser imaging detection and ranging (LIDAR) that measures a distance to a surrounding object by detecting scattered light of laser-emitted light.

The self-position estimation unit 82 estimates the current position and time of the mobile robot 20a body on the basis of the information acquired by the sensor unit 81.

The actuation unit 83 performs control of movement of the mobile robot 20a on the basis of the operation information transmitted from the information processing apparatus 10a.

The mobile body information transmission unit 84 transmits the image Ia and the sound acquired by the audio-visual information acquisition unit 80 to the information processing apparatus 10a together with the time ta at which the image Ia is captured. Further, the mobile body information transmission unit 84 transmits the position P(tb) of the mobile robot 20a estimated by the self-position estimation unit 82 and the time tb at the position P(tb) to the information processing apparatus 10a. Note that the time ta and the time tb do not necessarily match each other. This is because the mobile robot 20a transmits the image Ia and the position P(tb) independently.

That is, the mobile body information transmission unit 84 frequently transmits the position P(tb) for which the communication capacity is small and the encoding processing is light in comparison with the image Ia for which the communication capacity is large and the encoding processing is heavy. For example, the image Ia is transmitted at 60 frames per second, and the position P(tb) is transmitted about 200 times per second. Therefore, there is no guarantee that a position P(ta) of the mobile robot 20a at the time ta at which the image Ia is captured is transmitted. However, since the times ta and tb are times generated by the same timer of the CPU 52 included in the mobile robot 20a and the position P(tb) is frequently transmitted, the information processing apparatus 10a can calculate the position P(ta) by interpolation calculation.

The operation information reception unit 85 acquires the movement control information transmitted from the information processing apparatus 10a.

[2-6. Method for Estimating Current Position of Mobile Robot]

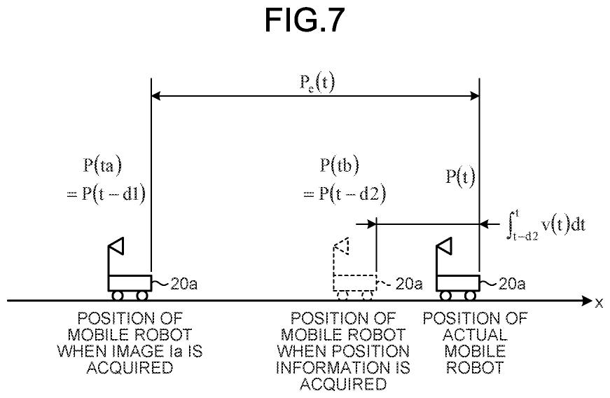

Next, a method for estimating the current position of the mobile robot 20a performed by the current position estimation unit 72 of the information processing apparatus 10a will be described. FIG. 7 is a diagram explaining a method for estimating a current position of the mobile robot.

As described above, the image acquisition unit 70a acquires the image Ia (first image) captured by the camera 26 included in the mobile robot 20a and the time ta at which the image Ia is captured. Further, the position acquisition unit 70b acquires the position P(tb) of the mobile robot 20a and the time tb at the position P(tb). Note that the position P(tb) transmitted by the mobile robot 20a and the time tb at the position P(tb) are hereinafter referred to as internal information of the mobile robot 20a. Note that the mobile robot 20a may further transmit the speed of the mobile robot 20a as the internal information.

Here, the current time is t, and the delay time of the image is d1. That is, Formula (2) is established.

ta=t−d1 (2)

Further, the position P(tb) of the mobile robot 20a acquired by the position acquisition unit 70b is also delayed by delay time d2 with respect to the position of the mobile robot 20a at the current time t. That is, Formula (3) is established.

tb=t−d2 (3)

Here, d1>d2. That is, as illustrated in FIG. 7, the position P(ta) of the mobile robot 20a at the time ta is different from the position P(tb) of the mobile robot 20a at the time tb, and the position P(tb) of the mobile robot 20a at the time tb is closer to the current position P(t) of the mobile robot 20a. This is because, as described above, the position information of the mobile robot 20a is communicated more frequently than the image. Note that the position P(ta) of the mobile robot 20a at the time ta is information that is not actually transmitted, and thus is obtained by interpolation using a plurality of positions P(tb) of the mobile robot 20a that is frequently transmitted.

The current position estimation unit 72 obtains a difference between a position P(t−d1) at which the camera 26 has captured the image Ia and the current position P(t) of the mobile robot 20a at the time when the operator 50 views the image via the information processing apparatus 10a. Hereinafter, this difference is referred to as a predicted position difference Pe(t). That is, the predicted position difference Pe(t) is calculated by Formula (4).

Pe(t)=P(t−d2)∫_{t-d2}^{t}v(t)dt (4)

Note that Formula (4) is an approximate expression on the assumption that the difference in coordinates between the current position P(t) and the position P(tb) of the mobile robot 20a is sufficiently small.

On the other hand, in a case where the difference in coordinates between the current position P(t) and the position P(tb) of the mobile robot 20a is not considered to be sufficiently small, for example, in a case where the mobile robot 20a is moving at a high speed, in a case where there is a delay in acquisition of the internal information of the mobile robot 20a due to a communication failure of a network or the like, in a case where a delay occurs when the display control unit 74 displays a video on the HMD 16, or in a case where a delay is intentionally added, the current position P(t) of the mobile robot 20a can be estimated by Formula (5).

P(t)−P(t−d2)=∫_{t-d2}^{t}v(t)dt (5)

Therefore, the predicted position difference Pe(t) is calculated by Formula (6).

Pₑ(t)=∫_{t-d2}^{t}v(t)dt+P(t−d2)−P(t−dl) (6)

Note that speed v(t) of the mobile robot 20a is the speed of the mobile robot 20a from time t−d2 to the current time t. The speed v(t) can be estimated from the input of the operator 50 to the operation input component 14 and the internal information of the mobile robot 20.

The current position estimation unit 72 estimates the current position P(t) of the mobile robot 20a by adding the moving direction and the moving amount of the mobile robot 20a according to the movement control information generated by the operation information generation unit 75 from the time t−d2 to the current time t to a position P(t−d2) of the mobile robot 20a acquired by the position acquisition unit 70b at the time t−d2 before the current time t in this manner.

The above description is for a case where the mobile robot 20a performs one-dimensional motion. Furthermore, even when the mobile robot 20a performs two-dimensional or three-dimensional motion, the estimation can be performed by a similar method. Further, the motion of the mobile robot 20a is not limited to a translational motion, and may be accompanied by a rotational motion.

That is, the current position estimation unit 72 estimates the current position P(t) of the mobile robot 20a by adding the moving direction and the moving amount of the mobile robot 20a according to the movement control information generated by the operation information generation unit 75 at the time t−d2 from the time t−d2 to the current time t to the position P(t−d2) of the mobile robot 20a acquired by the position acquisition unit 70b at the time tb which is a time before the current time t.

[2-7. Method for Generating Prediction Image]

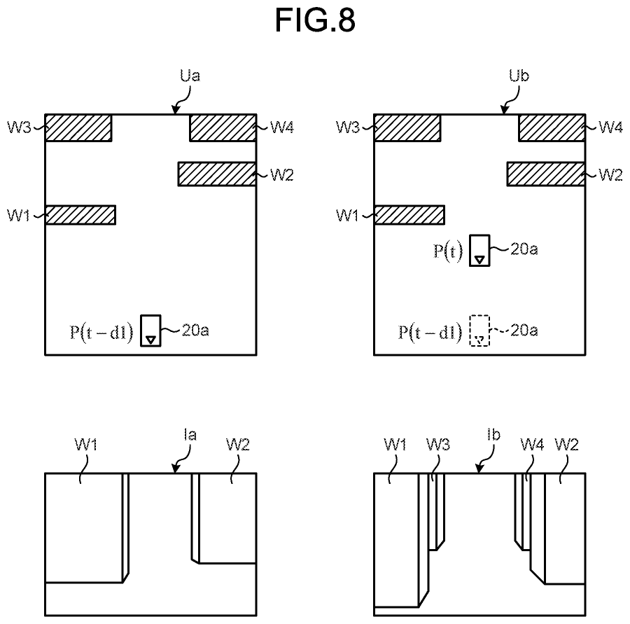

Next, a method for generating the image Ib (second image) according to the position of the mobile robot 20a performed by the image generation unit 73a of the information processing apparatus 10a will be described. FIG. 8 is a diagram explaining a method for generating a prediction image according to the first embodiment.

The image generation unit 73a generates the image Ib (second image) on the basis of the estimated current position P(t) of the mobile robot 20a. In particular, the information processing apparatus 10a according to the first embodiment moves the viewpoint position of the camera 26 from the position P(t-−d1) at which the image Ia (first image) has been acquired to the estimated current position P(t) of the mobile robot 20a, thereby generating the image Ib (second image) predicted to be captured at the virtual viewpoint of the movement destination.

Specifically, a three-dimensional model (hereinafter, referred to as a 3D model) of the surrounding space is generated from the image Ia captured by the camera 26 of the mobile robot 20a. Then, the viewpoint position of the virtual camera is calculated by offsetting the viewpoint position of the camera 26 to the current position P(t), and an image predicted to be captured at the viewpoint position of the virtual camera is generated on the basis of the generated 3D model of the surrounding space and the map data M stored in the mobile robot 20a. Such processing is referred to as delay compensation using a free viewpoint camera image. Note that, regarding the attitude of the camera 26, the viewpoint position can be generated by performing the same processing as the position of the camera 26, but the description will be omitted.

A top view Ua illustrated in FIG. 8 is a top view of an environment in which the mobile robot 20a is placed. Obstacles W1, W2, W3, and W4 exist in front of the mobile robot 20a. Further, the image Ia is an example of an image acquired by the mobile robot 20a at the position P(t−d1). The obstacles W1 and W2 are illustrated in the image Ia, and the obstacles W3 and W4 are not illustrated because they are blind spots.

On the other hand, a top view Ub illustrated in FIG. 8 is a top view in a case where the mobile robot 20a is at the current position P(t) estimated by the information processing apparatus 10a. Then, the image Ib is an example of an image predicted to be captured from the current position P(t) of the mobile robot 20a.

As illustrated in the image Ib, the obstacles W3 and W4 not illustrated in the image Ia can be imaged by utilizing the map data M. That is, the image Ib without occlusion can be generated. As described above, in the present embodiment, 3D reconstruction is performed from the viewpoint of the camera 26 included in the mobile robot 20a. Then, the actual position P(t−d1) of the camera 26 in the 3D model space is offset to the current position P(t), that is, the position of the virtual camera, and the image Ib predicted to be captured by the virtual camera is generated and presented to the operator 50, thereby compensating for the delay with respect to the operation input of the operator 50.

Note that as the 3D model, a model of a three-dimensional space generated in advance is used. For example, some existing map databases include 3D model data. Furthermore, it is considered that more detailed and high image quality map data will be provided in the future. Further, the 3D model may be updated from the image captured by the camera 26 included in the mobile robot 20a, for example, using the SLAM technique.

A static environment model may be constructed by acquiring 3D model data around the mobile robot 20a from the server, and a free viewpoint may be generated by constructing a model like a person or a moving object on the basis of a video captured by the camera 26. Further, the free viewpoint image may be generated using information of a camera arranged other than the mobile robot 20a (fixed camera installed on environmental side, mobile camera included in another mobile robot). As described above, by using the information of the camera arranged other than the mobile robot 20a, it is possible to cope with the problem that an image including a blind spot by occlusion is generated when a viewpoint ahead in the traveling direction is generated in a case where the 3D model is generated only by the camera 26 included in the mobile robot 20a.

Further, a map around the mobile robot 20a may be generated from an omnidirectional distance sensor such as the LIDAR described above, a 3D model of the environment may be generated with respect to the generated map, and the video of the omnidirectional image may be mapped, and the same operation may be performed.

Note that the information processing apparatus 10a may generate an image viewed from an objective viewpoint as in the image J2 of FIG. 1.

As described above, the information processing apparatus 10a is characterized in that delay compensation is performed by generating the image Ib predicted to be captured at the current position P(t) of the mobile robot 20a on the basis of an accurate unit by performing a strict arithmetic operation.

[2-8. Flow of Processing of First Embodiment]

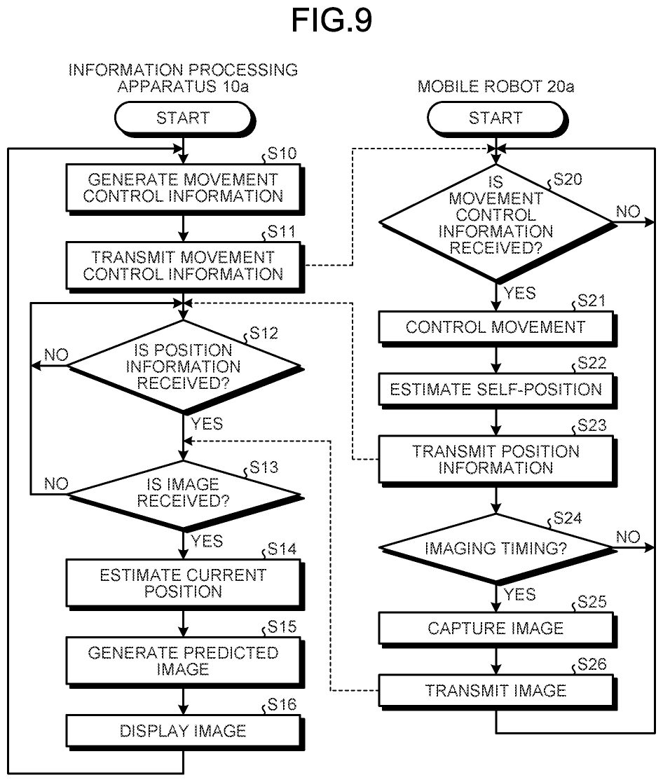

A flow of processing performed by the information processing system 5a of the present embodiment will be described with reference to FIG. 9. FIG. 9 is a flowchart illustrating an example of a flow of processing performed by the information processing system according to the first embodiment.

First, a flow of processing performed by the information processing apparatus 10a will be described. The operation information generation unit 75 generates movement control information on the basis of an operation instruction given by the operator 50 to the operation input component 14 (step S10).

The operation information transmission unit 76 transmits the movement control information generated by the operation information generation unit 75 to the mobile robot 20a (step S11).

The position acquisition unit 70b determines whether the position information has been received from the mobile robot 20a (step S12). When it is determined that the position information has been received from the mobile robot 20a (step S12: Yes), the processing proceeds to step S13. On the other hand, when it is not determined that the position information has been received from the mobile robot 20a (step S12: No), step S12 is repeated.

The image acquisition unit 70a determines whether the image Ia has been received from the mobile robot 20a (step S13). When it is determined that the image Ia has been received from the mobile robot 20a (step S13: Yes), the processing proceeds to step S14. On the other hand, when it is not determined that the image Ia has been received from the mobile robot 20a (step S13: No), the processing returns to step S12.

The current position estimation unit 72 estimates the current position P(t) of the mobile robot 20a on the basis of the position P(tb) of the mobile robot 20a acquired by the position acquisition unit 70b, the time tb at the position P(tb), the movement control information generated by the operation information generation unit 75, and the map data M stored in the mobile robot 20a (step S14).

The image generation unit 73a generates the image Ib (second image), that is, the image Ib predicted to be captured at the current position P(t) of the mobile robot 20a estimated in step S14 (step S15).

The display control unit 74 displays the image Ib on the HMD 16 (step S16). Thereafter, the processing returns to step S10, and the above-described processing is repeated.

Next, a flow of processing performed by the mobile robot 20a will be described. The operation information reception unit 85 determines whether the movement control information has been received from the information processing apparatus 10a (step S20). When it is determined that the movement control information has been received from the information processing apparatus 10a (step S20: Yes), the processing proceeds to step S21. On the other hand, when it is not determined that the movement control information has been received from the information processing apparatus 10a (step S20: No), step S20 is repeated.

When it is determined to be Yes in step S20, the actuation unit 83 performs movement control of the mobile robot 20a on the basis of the movement control information acquired by the operation information reception unit 85 (step S21).

The self-position estimation unit 82 estimates the self-position of the mobile robot 20a by referring to the information acquired by the sensor unit 81 (step S22).

The mobile body information transmission unit 84 transmits the position information of the mobile robot 20a and the time present in the position information to the information processing apparatus 10a (step S23).

The audio-visual information acquisition unit 80 determines whether it is the imaging timing of the camera 26 (step S24). The determination in step S24 is performed because the image Ia captured by the camera 26 has a large data amount and thus cannot be transmitted to the information processing apparatus 10a frequently, so that the determination is performed to wait for the timing at which the transmission becomes possible. When it is determined that it is the imaging timing of the camera 26 (step S24: Yes), the processing proceeds to step S25. On the other hand, when it is not determined that it is the imaging timing of the camera 26 (step S24: No), the processing returns to step S20.

When it is determined to be Yes in step S24, the audio-visual information acquisition unit 80 causes the camera 26 to capture an image (step S25). Note that, although not illustrated in the flowchart of FIG. 9, the audio-visual information acquisition unit 80 records a sound with the microphone 28 and transmits the recorded sound to the information processing apparatus 10a.

Subsequently, the mobile body information transmission unit 84 transmits the image Ia captured by the camera 26 to the information processing apparatus 10a (step S26). Thereafter, the processing returns to step S20, and the above-described processing is repeated.

Note that, in addition to the processing illustrated in FIG. 9, the information processing apparatus 10a can perform delay compensation even when generating the image Ib only from the mobile body control information without estimating the current position P(t) of the mobile robot 20a (mobile body). A specific example will be described in the second embodiment.

[2-9. Effect of First Embodiment]

As described above, in the information processing apparatus 10a, the mobile body information reception unit 70 receives the mobile body information including the image Ia (first image) captured by the camera 26 (imaging unit) mounted on the mobile robot 20a (mobile body). Further, the operation information generation unit 75 generates operation information including the movement control information for instructing the mobile robot 20a to move on the basis of the input to the operation input unit 79. The operation information transmission unit 76 transmits the operation information including the movement control information to the mobile robot 20a. Then, the image generation unit 73a generates the image Ib (second image) corresponding to the movement of the mobile robot 20a indicated by the movement control information from the image Ia on the basis of the movement control information received by the mobile body information reception unit 70.

Thus, the image Ib corresponding to the movement of the mobile robot 20a can be generated in consideration of the movement control information generated by the operation information generation unit 75. Therefore, it is possible to unfailingly compensate for the occurrence of a delay when the image captured by the camera 26 is displayed on the HMD 16 regardless of the magnitude of the operation instruction given by the operator 50 to the mobile robot 20a. Note that when the image Ib is generated only from the movement control information without estimating the current position of the mobile robot 20a, the processing load required for the calculation can be reduced.

Further, in the information processing apparatus 10a, the movement control information includes the moving direction and the moving amount of the mobile robot 20a (mobile body).

Thus, an appropriate movement instruction can be given to the mobile robot 20a.

Furthermore, in the information processing apparatus 10a, the mobile body information received by the mobile body information reception unit 70 further includes the position information indicating the position of the mobile robot 20a (mobile body) at the current time t at which the image Ia (first image) is captured, and the current position estimation unit 72 estimates the current position P(t) of the mobile robot 20a (mobile body) at the current time t on the basis of the position information and the operation information transmitted by the operation information transmission unit 76.

Thus, it becomes possible to accurately predict the current position P(t) of the mobile robot 20a regardless of the magnitude of the operation instruction given to the mobile robot 20a by the operator 50. In particular, by estimating the current position P(t) of the mobile robot 20a, the image Ib accurately reflecting the current position of the camera 26 can be generated.

Furthermore, in the information processing apparatus 10a, the image generation unit 73a generates the image Ib (second image) corresponding to the current position P(t) of the mobile robot 20a (mobile body) estimated by the current position estimation unit 72 from the image Ia (first image).

Thus, it becomes possible to generate the image Ib predicted to be captured by the mobile robot 20a at the current position P(t).

Further, in the information processing apparatus 10a, the display control unit 74 causes the display unit 90 to display the image Ib (second image).

Thus, it becomes possible to display the image Ib predicted to be captured by the mobile robot 20a at the current position P(t), making it possible to unfailingly compensate for occurrence of a delay when the image captured by the camera 26 is displayed on the display unit 90.

Further, in the information processing apparatus 10a, the image Ib (second image) is an image predicted to be captured from the viewpoint position of the camera 26 (imaging unit) corresponding to the current position of the mobile robot 20a (mobile body) estimated by the current position estimation unit 72.

Thus, the information processing apparatus 10a displays the image Ib predicted to be captured by the camera 26 included in the mobile robot 20a on the HMD 16, so that it is possible to present an image captured from the viewpoint position at the accurate current position of the mobile robot 20a.

Further, in the information processing apparatus 10a, the current position estimation unit 72 estimates the current position P(t) of the mobile robot 20a by adding the moving direction and the moving amount of the mobile robot 20a according to the movement control information generated by the operation information generation unit 75 from the time t−d2 to the current time t to the position P(t−d2) of the mobile robot 20a acquired by the position acquisition unit 70b at the time t−d2 before the current time t.

Thus, the information processing apparatus 10a can accurately estimate the current position P(t) of the mobile robot 20a in consideration of an operation instruction given by the operator 50 to the mobile robot 20a.

Further, in the information processing apparatus 10a, the display control unit 74 displays the image Ib (second image) on the HMD 16.

Thus, the operator 50 can observe an image with realistic feeling.

Further, since the information processing apparatus 10a can perform delay compensation, it is possible to execute processing having a high load in which a delay occurs. For example, it is possible to perform image quality enhancement processing of the image Ib. Further, the image quality of the image Ib can be stabilized by performing buffering.

Furthermore, since the information processing apparatus 10a can perform delay compensation, the moving speed of the mobile robot 20a can be increased. Furthermore, the system cost of the information processing system 5a can be reduced.

[2-10. Variation of First Embodiment]

Next, an information processing system 5b, which is a variation of the information processing system 5a described in the first embodiment, will be described. Note that the hardware configuration of the information processing system 5b is the same as the hardware configuration of the information processing system 5a, and thus the description thereof will be omitted.

[2-11. Functional Configuration of Variation of First Embodiment]

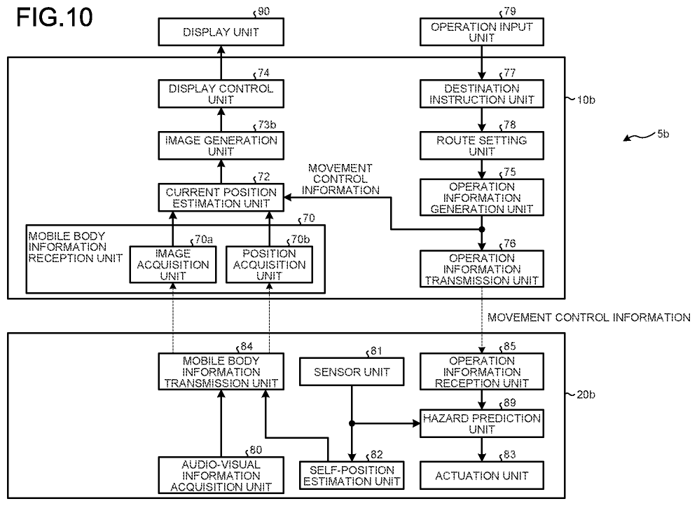

The information processing system 5b includes an information processing apparatus 10b and a mobile robot 20b. FIG. 10 is a functional block diagram illustrating an example of a functional configuration of the information processing system 5b. The information processing system 5b includes the information processing apparatus 10b and the mobile robot 20b. Note that the mobile robot 20b is an example of the mobile body.

The information processing apparatus 10b includes a destination instruction unit 77 and a route setting unit 78 in addition to the configuration of the information processing apparatus 10a (see FIG. 6). Further, the information processing apparatus 10b includes an image generation unit 73b instead of the image generation unit 73a.

The destination instruction unit 77 instructs a destination that is a movement destination of the mobile robot 20b. Specifically, the destination instruction unit 77 sets a destination on the basis of an instruction from the operator 50 with respect to the map data M included in the information processing apparatus 10b via the operation input unit 79. The position of the set destination is transmitted to the mobile robot 20b as movement control information generated by the operation information generation unit 75.

Note that the destination instruction unit 77 instructs a destination by, for example, instructing a predetermined place of the map data M displayed on the HMD 16 using the operation input component 14 such as a game pad. Further, the destination instruction unit 77 may set, as the destination, a point instructed by the operation input component 14 from the image Ia captured by the mobile robot 20b and displayed on the HMD 16.

The route setting unit 78 refers to the map data M to set a moving route to the destination instructed by the destination instruction unit 77. The set moving route is transmitted to the mobile robot 20b as movement control information generated by the operation information generation unit 75.

The operation information generation unit 75 sets the moving route set by the route setting unit 78 as movement control information described in a set of point sequences (waypoints) followed by the moving route. Further, the operation information generation unit 75 may set the moving route set by the route setting unit 78 as movement control information described as a movement instruction at each time. For example, it may be a time-series movement instruction such as forward movement for 3 seconds after start, then right turn, and then backward movement for 2 seconds. Then, the operation information transmission unit 76 transmits the generated movement control information to the mobile robot 20b. Note that the processing of performing the route setting from the information of the destination instructed by the destination instruction unit 77 may be performed by the mobile robot 20b itself. In this case, information of the destination instructed by the destination instruction unit 77 of the information processing apparatus 10b is transmitted to the mobile robot 20b, and the mobile robot 20b sets its own moving route using the route setting unit 78 provided in the mobile robot 20b.

The image generation unit 73b generates the image Ib (second image) viewing the direction of the destination from the current position of the mobile robot 20b from the image Ia (first image) on the basis of the current position of the mobile robot 20b estimated by the current position estimation unit 72, the position of the mobile robot 20b at the time when the image Ia is captured, and the position of the destination.

The mobile robot 20b includes a hazard prediction unit 89 in addition to the configuration of the mobile robot 20a (see FIG. 6). Furthermore, the camera 26 includes an ultra-wide-angle lens or a fisheye lens that captures an image of the traveling direction of the mobile robot 20b in a wide range. Alternatively, it is assumed that the camera 26 includes a multi-camera and captures an image of the entire periphery.

The hazard prediction unit 89 predicts whether there is an obstacle in the traveling direction of the mobile robot 20b on the basis of the output of the distance measuring sensor included in the sensor unit 81, and further the hazard prediction unit 89 instructs the actuation unit 83 on a moving route for avoiding the obstacle in a case where it is determined that there is an obstacle in the traveling direction of the mobile robot 20b. That is, the mobile robot 20b has a function of autonomously changing the moving route according to its own determination.

[2-12. Method for Generating Prediction Image]

Next, a method for generating the image Ib (second image) according to the position of the mobile robot 20b performed by the image generation unit 73b of the information processing apparatus 10b will be described.

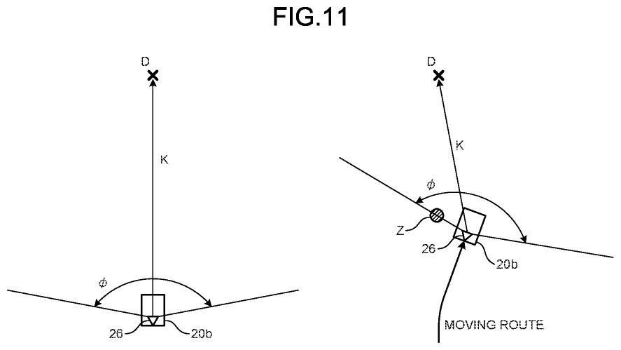

FIG. 11 is a diagram explaining a method for generating a prediction image according to a variation of the first embodiment. As illustrated in FIG. 11, a scene is assumed where the mobile robot 20b travels straight toward a destination D. At this time, the image generation unit 73b generates the image Ib in which a direction K from the mobile robot 20b toward the destination D is located at the center of the display screen and the delay is compensated. Then, the image Ib is presented to the operator 50.

In this case, the image generation unit 73b first calculates a position in the horizontal direction corresponding to the direction of the destination D in the image Ia captured by the camera 26. Then, the image generation unit 73b rotates the image Ia in the horizontal direction such that the position in the horizontal direction calculated from the image Ia and corresponding to the direction of the destination D is at the center of the screen. When the mobile robot 20b faces the direction of the destination D, it is not necessary to rotate the image Ia in the horizontal direction.

Next, when an obstacle Z is present in the traveling direction of the mobile robot 20b, the sensor unit 81 of the mobile robot 20b detects the presence of the obstacle Z in advance. Then, the hazard prediction unit 89 instructs the actuation unit 83 on a moving route for avoiding the obstacle Z.

Then, the actuation unit 83 changes the moving route of the mobile robot 20b so as to avoid the obstacle Z as illustrated in FIG. 11. At this time, as the moving route of the mobile robot 20b is changed, the orientation of an imaging range φ of the camera 26 changes.

At this time, the image generation unit 73b rotates the image Ia in the horizontal direction such that the direction K from the mobile robot 20b toward the destination D is located at the center of the display screen.

In this case, since the image center of the image Ia captured by the camera 26 does not face the direction of the destination D, the image generation unit 73b calculates which position in the imaging range φ the direction from the camera 26 toward the destination D corresponds to. Then, the image generation unit 73b rotates the image Ia in the horizontal direction such that the position in the calculated imaging range φ is located at the center of the image. Furthermore, the image generation unit 73b generates a delay-compensated image Ib with respect to the rotated image Ia according to the procedure described in the first embodiment. Then, the image Ib is presented to the operator 50.

Thus, in a case where the change in the range of the field of view of the camera 26 is large as in a case where the mobile robot 20b makes a large course change, the information processing apparatus 10b presents a more suitable image such as an image in the direction of the destination D instead of faithfully displaying the image of the range of the field of view of the camera 26 to the operator 50.

Note that, even when a swing mechanism is provided to the camera 26 included in the mobile robot 20b to perform control such that the camera 26 always faces the direction of the destination D, the same action as described above can be performed.

[2-13. Effect of Variation of First Embodiment]

As described above, in the information processing apparatus 10b, the destination instruction unit 77 instructs the destination D of the mobile robot 20b (mobile body). Then, the image generation unit 73b generates the image Ib (second image) viewing the direction of the destination D from the current position of the mobile robot 20b from the image Ia (first image) on the basis of the current position of the mobile robot 20b estimated by the current position estimation unit 72 and the position of the mobile robot 20b at the time when the image Ia is captured.

Thus, the information processing apparatus 10b can present the image Ib having a small change in the field of view to the operator 50. That is, by not faithfully reproducing the camerawork in the image Ib, it is possible to prevent the occurrence of motion sickness (VR sickness) of the operator (observer) due to a change in the field of view at an unexpected timing.

(3. Second Embodiment)

A second embodiment of the present disclosure is an example of an information processing system 5c (not illustrated) including an image display function that causes an illusion of perception of the operator 50. The information processing system 5c includes an information processing apparatus 10c (not illustrated) and a mobile robot 20a.

Since the hardware configuration of the information processing apparatus 10c is the same as the hardware configuration of the information processing apparatus 10a, the description thereof will be omitted.

[3-1. Outline of Information Processing Apparatus]

While the information processing apparatus 10a of the first embodiment constructs a 3D model, reflects an accurate position of a robot on a viewpoint position, and uses a correct viewpoint position, the information processing apparatus 10c of the second embodiment performs delay compensation of an image by presenting an image using an expression that causes an illusion of perception of the operator 50. The expression that causes an illusion of perception of the operator 50 is, for example, a visual effect in which when another train that has started moving is viewed from a stopped train, the operator feels as if the train on which the operator is riding is moving (train illusion). That is, the second embodiment compensates for the delay of the image by presenting the operator 50 with the feeling that the mobile robot 20a is moving.

The visual effect described above is generally called the VECTION effect (visually induced self-motion perception). This phenomenon is a phenomenon in which when there is uniform movement in the field of view of the observer, the observer perceives that observer itself is moving. In particular, when the movement pattern is presented in the peripheral vision area rather than the central vision area, the VECTION effect appears more remarkably.

While the first embodiment reproduces motion parallax when the mobile robot 20a performs translational motion, the video (image) generated in the second embodiment does not reproduce accurate motion parallax. However, by generating and presenting a video in which the VECTION effect occurs on the basis of the predicted position difference Pe(t), it is possible to virtually give a sense that the camera 26 is moving, and this can compensate for the delay of the image.

[3-2. Functional Configuration of Information Processing Apparatus]

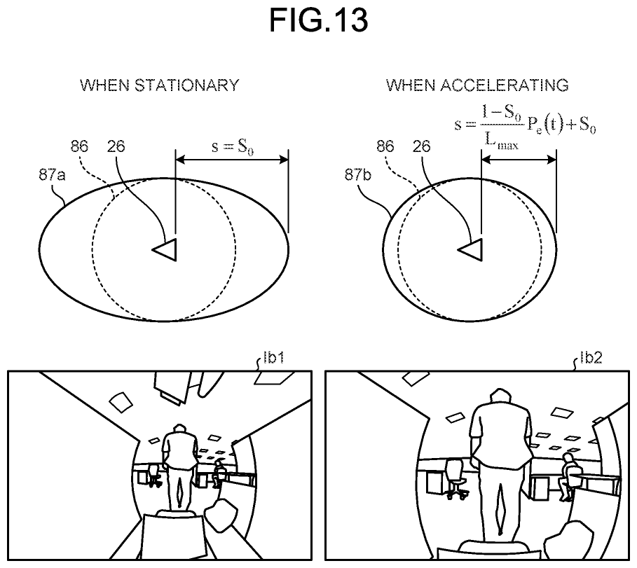

The information processing apparatus 10c (not illustrated) includes an image generation unit 73c (not illustrated) instead of the image generation unit 73a included in the information processing apparatus 10a. The image generation unit 73c generates, from the image Ia, an image Ib (second image) having a video effect (for example, VECTION effect) that causes an illusion of a position change of the mobile robot 20a corresponding to the position of the mobile robot 20a at the time to at which the image Ia is captured, on the basis of the current position P(t) of the mobile robot 20a estimated by the current position estimation unit 72 and the map data M stored in the mobile robot 20a. Images Ib1 and Ib2 in FIG. 13 are examples of the image Ib. Details will be described later.

[3-3. Method for Generating Prediction Image]

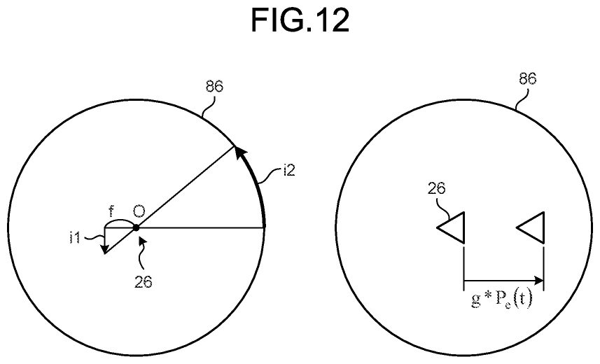

FIG. 12 is an explanatory diagram of a spherical screen. As illustrated in FIG. 12, a projection image i2 is generated by projecting the light emitted from an image i1 captured by the camera 26 (imaging unit) and formed at the position of a focal length f to a position where the light that has passed through a pinhole O and reached a spherical screen 86, which is an example of a curved surface surrounding the camera 26.

Then, as illustrated in FIG. 12, the camera 26 placed at the center of the spherical screen 86 as the initial position is moved to a position corresponding to the predicted position difference Pe(t) described in the first embodiment. However, since the omnidirectional video is a video having no distance, that is, the projection direction of the projection image i2 does not change even if the radius of the spherical screen 86 on which the omnidirectional video is projected is changed, the predicted position difference Pe(t) cannot be used as it is when calculating the movement destination of the camera 26, that is, the position of the virtual camera. Therefore, the image is adjusted by introducing a scale variable g. The scale variable g may be a fixed value or a parameter that linearly or nonlinearly changes according to the acceleration, speed, position, and the like of the mobile robot 20a.

Note that, in FIG. 12, the initial position of the camera 26 is placed at the center of the spherical screen 86, but the initial position may be offset. That is, by offsetting the virtual camera position to the rear side of the mobile robot 20a as much as possible, it is possible to suppress the influence of deterioration in image quality when the virtual camera approaches the spherical screen 86. This is because the state in which the virtual camera approaches the spherical screen 86 is generated by enlarging (zooming) the image captured by the camera 26, but since the roughness of the resolution becomes conspicuous when the image is enlarged, it is desirable to install the camera 26 at a position as far away from the spherical screen 86 as possible.

FIG. 13 is a diagram explaining a method for generating a prediction image according to the second embodiment. As illustrated in FIG. 13, the image generation unit 73b described above deforms the shape of the spherical screen 86 (curved surface) according to the moving state of the mobile robot 20a. That is, when the mobile robot 20a is stationary, the spherical screen 86 is deformed into a spherical screen 87a. Further, when the mobile robot 20a is accelerating (or decelerating), the spherical screen 86 is deformed into a spherical screen 87b.

Then, the image generation unit 73c generates the image Ib by projecting the image Ia onto the deformed spherical screens 87a and 87b. Specifically, the image generation unit 73c deforms the shape of the spherical screen 86 with respect to the direction of the predicted position difference Pe(t) according to Formula (7).

$$s = \frac{1 - {S}_{0}}{{L}_{max}} {P}_{e} ( t ) + {S}_{0} \qquad ( 7 )$$

The scale variable s in Formula (7) is a variable indicating how many times the scale of the image Ib is to be made with respect to the spherical screen 86. Further, Lmax is the maximum value of the assumed predicted position difference Pe(t), and So is the scale amount in a case where the mobile robot 20a is stationary. Note that Formula (7) is an example, and the image Ib may be generated using a formula other than Formula (7).

In a case where the mobile robot 20a is stationary, the image generation unit 73c deforms the spherical screen 86 so as to stretch the spherical screen 86 in the direction of the camera 26 (including the opposite direction). The deformation amount, that is, the scale variable s is calculated by Formula (7). The image generation unit 73c projects the image Ia onto the deformed spherical screen 87a to generate an image Ib1 (an example of the second image). At this time, the scale variable s=S₀ by calculation of Formula (7).

Since the spherical screen 87a is stretched in the direction of the camera 26, the image Ib1 is an image in which perspective is emphasized.

On the other hand, when the mobile robot 20a is accelerating, the image generation unit 73c reduces the scale variable s of the spherical screen 86. The scale variable s is calculated by Formula (7). The image generation unit 73c projects the image Ia onto the deformed spherical screen 87b to generate an image Ib2 (an example of the second image).

Since the image Ib2 is compressed in the perspective direction, an atmosphere in which the camera 26 further approaches the front is created. Thus, the image Ib2 exhibits a strong VECTION effect.

Note that the deformation direction of the spherical screen 86 is determined on the basis of the attitude of the mobile robot 20a. Therefore, for example, in a case where the mobile robot 20a is a drone and can move forward, backward, left, right, and obliquely, the image generation unit 73c deforms the spherical screen 86 in the direction in which the mobile robot 20a has moved.

Note that even when the image Ib generated by the method described in the first embodiment is projected on a spherical screen 87 deformed as illustrated in FIG. 11 to form the image Ib1 or the image Ib2, a similar VECTION effect is exhibited.

As described above, unlike the first embodiment, the information processing apparatus 10b is characterized in that delay compensation is performed by generating the images Ib1 and Ib2 that cause an illusion of the viewpoint position change of the operator 50 without generating the image Ib predicted to be captured at the current position P(t) of the mobile robot 20a.

[3-4. Other Method for Generating Prediction Image]

The image generation unit 73b may generate the image Ib by another method of giving the VECTION effect. FIG. 14 is a first diagram explaining another method for generating the prediction image according to the second embodiment.

Computer graphics (CGs) 88a and 88b illustrated in FIG. 14 are examples of an image to be superimposed on the image Ia captured by the camera 26.

The CG 88a is a scatter diagram of a plurality of dots having random sizes and random brightness. Then, the CG 88a represents a so-called warp representation in which the dots move radially with time.

The CG 88b is obtained by radially arranging a plurality of line segments having random lengths and random brightness. Then, the CG 88b represents a so-called warp representation in which the line segments move radially with time.

Note that the moving speed of the dot or the line segment may be changed according to a derivative value of the predicted position difference Pe(t). For example, in a case where the derivative value of the predicted position difference Pe(t) is large, that is, in a case where the delay time is large, warp representation with a higher moving speed may be performed. Further, FIG. 14 illustrates an example in which dots and line segments spread in all directions, but the expression form is not limited thereto, and, for example, the warp representation may be applied only to a limited range such as a lane of a road.

The image generation unit 73b superimposes the CG 88a on the image Ib2 to generate an image Ib3 (an example of the second image) illustrated in FIG. 14. Thus, by adding the warp representation, the VECTION effect can be more strongly exhibited.

Further, the image generation unit 73b may superimpose the CG 88b on the image Ib2 to generate an image Ib4 (an example of the second image) illustrated in FIG. 14. Thus, by adding the warp representation, the VECTION effect can be more strongly exhibited.

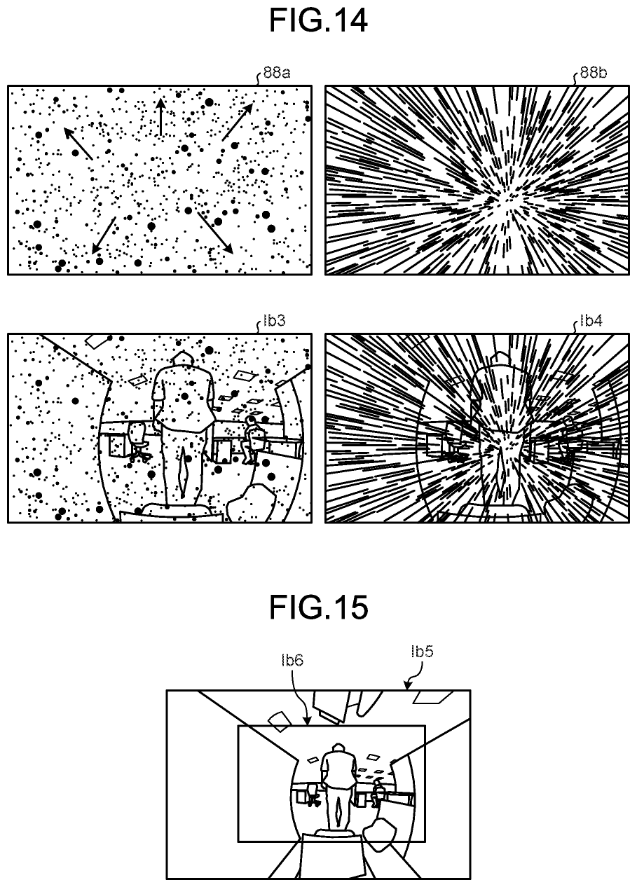

FIG. 15 is a second diagram explaining another method for generating the prediction image according to the second embodiment. In the example of FIG. 15, the viewing angle (field of view) of the camera 26 is changed according to the moving state of the mobile robot 20a.

That is, when the mobile robot 20a is stationary, an image Ib5 (an example of the second image) having a large viewing angle of the camera 26 is displayed. On the other hand, when the mobile robot 20a is moving, an image Ib6 (an example of the second image) having a small viewing angle of the camera 26 is displayed.

Note that the change in the viewing angle of the camera 26 may be realized by using, for example, a zooming function of the camera 26. It may be realized by trimming the image Ia captured by the camera 26.

Note that the above description is an example in which information is presented by a video (image), but a larger sense of movement can be presented by using a multimodal. For example, the volume, pitch, or the like of the moving sound of the mobile robot 20a may be changed and presented according to the prediction difference. Further, the sound image localization may be changed according to the moving state of the mobile robot 20a. Similarly, information indicating a sense of movement may be presented to the sense of touch of a finger of the operator 50 via operation input component 14, for example. Further, a technique for presenting an acceleration feeling by electrical stimulation is known, but such a technique may be used in combination.

[3-5. Effect of Second Embodiment]

As described above, in the information processing apparatus 10c, the images Ib1, Ib2, Ib3, and Ib4 (second images) are images having a video effect of causing an illusion of a position change of the mobile robot 20a according to the position of the mobile robot 20a (mobile body) at the time when the image Ia (first image) is captured and the current position of the mobile robot 20 estimated by the current position estimation unit 72.

Thus, the information processing apparatus 10c can transmit the fact that the mobile robot 20a is moving to the operator 50 as a visual effect in response to the operation instruction of the operator 50, and thus it is possible to make it difficult to sense the delay of the image by improving the responsiveness of the system. That is, the delay of the image can be compensated.

Further, in the information processing apparatus 10c, the images Ib1, Ib2, Ib3, and Ib4 (second images) are generated by projecting the image Ia (first image) onto a curved surface deformed in accordance with a difference between the position of the mobile robot 20a at the time when the image Ia is captured and the current position of the mobile robot 20a estimated by the current position estimation unit 72.

Thus, the information processing apparatus 10c can easily generate an image having a video effect that causes an illusion of a position change of the mobile robot 20a.

Further, in the information processing apparatus 10c, the curved surface is a spherical surface installed so as to surround the camera 26 (imaging unit).

Thus, the information processing apparatus 10c can generate an image having a video effect that causes an illusion of a position change of the mobile robot 20a regardless of the observation direction.

Further, in the information processing apparatus 10c, the images Ib1, Ib2, Ib3, and Ib4 (second images) are images obtained by applying the VECTION effect to the image Ia (first image).

Thus, the information processing apparatus 10c can more strongly transmit the fact that the mobile robot 20a is moving to the operator 50 as a visual effect in response to the operation instruction of the operator 50, and thus it is possible to compensate for the delay of the image.

(4. Third Embodiment)

A third embodiment of the present disclosure is an example of an information processing system 5d (not illustrated) having a function of drawing an icon representing a virtual robot at a position corresponding to the current position of the mobile robot 20a in the image Ia. The information processing system 5d includes an information processing apparatus 10d (not illustrated) and the mobile robot 20a.

Since the hardware configuration of the information processing apparatus 10d is the same as the hardware configuration of the information processing apparatus 10a, the description thereof will be omitted.

[4-1. Outline of Information Processing Apparatus]

The information processing apparatus 10d displays an icon Q2 of a virtual robot R in the field of view of the virtual camera as in the image J3 illustrated in FIG. 1. By displaying such an image, the operator 50 has a sense of controlling the virtual robot R (hereinafter, referred to as an AR robot R) instead of controlling the mobile robot 20a itself. Then, the position of the actual mobile robot 20a is controlled as camerawork that follows the AR robot R. In this manner, by drawing the AR robot R at the current position of the mobile robot 20a, that is, a position offset by the predicted position difference Pe(t) from the position where the image Ia is captured, the expression in which the delay is compensated can be realized.

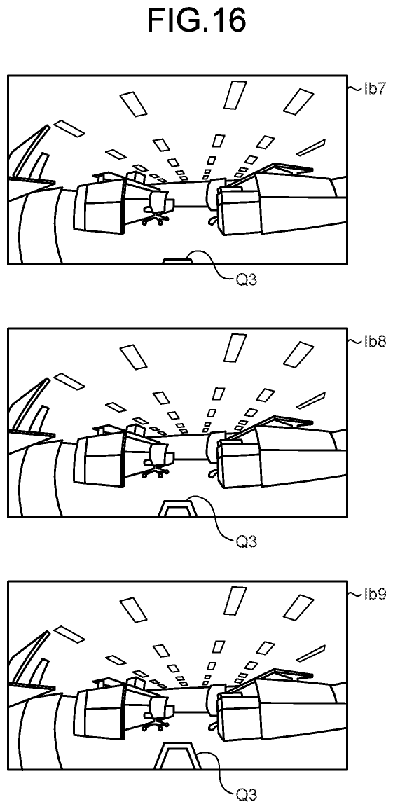

Note that the information processing apparatus 10d may draw the icon Q2 that completely looks down on the AR robot R as in the image J3 in FIG. 1, or may draw an icon Q3 so that only a part of the AR robot R is visible as illustrated in FIG. 16.

Each of images Ib7, Ib8, and Ib9 (an example of the second image) illustrated in FIG. 16 is an example in which the icon Q3 in which only a part of the AR robot R is visible is drawn. The superimposing amount of the icon Q3 in each image is different. That is, the image Ib7 is an example in which the superimposing amount of the icon Q3 is the smallest. Conversely, the image Ib9 is an example in which the superimposing amount of the icon Q3 is the largest. Then, the image Ib8 is an example in which the superimposing amount of the icon Q3 is intermediate between the two. Which icon Q3 illustrated in FIG. 16 to draw may be set appropriately.

By changing the drawing amount of the icon Q3, the amount of information necessary for maneuvering the mobile robot 20a changes. That is, when the small icon Q3 is drawn, the image information in front of the mobile robot 20a relatively increases, but the information in the immediate left and right of the mobile robot 20a decreases. On the other hand, when the large icon Q3 is drawn, the image information in front of the mobile robot 20a relatively decreases, but the information in the immediate left and right of the mobile robot 20a increases. Therefore, it is desirable that the superimposing amount of the icon Q3 can be changed at the discretion of the operator 50.

In general, by superimposing the icon Q3, it is possible to improve operability when the operator 50 operates the mobile robot 20a while viewing the images Ib7, Ib8, and Ib9. That is, the operator 50 recognizes the icon Q3 of the AR robot R as the mobile robot 20a maneuvered by the operator 50. That is, the images Ib7, Ib8, and Ib9 include are images viewed from the subjective viewpoint and include an objective viewpoint element by displaying the icon Q3 of the AR robot R. Therefore, the images Ib7, Ib8, and Ib9 enable easy understanding of the positional relationship between the mobile robot 20a and the external environment as compared, for example, with the image J1 (FIG. 1) and are images with which the mobile robot 20a can be more easily operated.

As described above, the information processing apparatus 10d is different from the first embodiment and the second embodiment in that delay compensation is performed by generating the images Ib7, Ib8, and Ib9 viewed from the AR objective viewpoint.

[4-2. Functional Configuration of Information Processing Apparatus]

The information processing apparatus 10d includes an image generation unit 73d (not illustrated) instead of the image generation unit 73a included in the information processing apparatus 10a.

The image generation unit 73d superimposes the icon Q2 imitating a part or the whole of the mobile robot 20a on the image Ia (first image). The superimposed position of the icon Q2 is a position offset from the position where the mobile robot 20a has captured the image Ia by the predicted position difference Pe(t), that is, the current position of the mobile robot 20a (mobile body) estimated by the current position estimation unit 72.

[4-3. Effect of Third Embodiment]

As described above, in the information processing apparatus 10d, the image generation unit 73d superimposes a part or the whole of the mobile robot 20a (mobile body) in the image Ia (first image).

Thus, the information processing apparatus 10d can present the images Ib7, Ib8, and Ib9, which are images viewed from the subjective viewpoint but include an objective viewpoint element, to the operator 50. Therefore, delay compensation is performed, and the operability when the operator 50 operates the mobile robot 20a can be improved.

Further, in the information processing apparatus 10d, the image generation unit 73d superimposes information representing a part or the whole of the mobile robot 20a on the current position of the mobile robot 20a (mobile body) estimated by the current position estimation unit 72 in the image Ia (first image).

Thus, the operator 50 can unfailingly recognize the current position of the mobile robot 20a.

Further, in the information processing apparatus 10d, the information representing the mobile robot 20a (mobile body) is the icons Q2 and Q3 imitating the mobile robot 20a.

Thus, the operator 50 can unfailingly recognize the current position of the mobile robot 20a.

(5. Notes at the Time of System Construction)

Further notes at the time of constructing the information processing systems 5a to 5d described above will be described.

[5-1. Installation Position of Camera]

In each of the embodiments described above, the shapes of the actual mobile robots 20a and 20b and the installation position of the camera 26 may not necessarily match the shapes of the mobile robots 20a and 20b and the installation position of the camera 26 felt when the operator 50 performs remote control.

That is, the camera 26 mounted on the mobile robots 20a and 20b is desirably installed at the foremost position in the traveling direction. This is to prevent the occurrence of hiding due to occlusion in the image captured by the camera 26 as much as possible. However, the operator 50 may perceive as if the camera 26 is installed behind the mobile robots 20a and 20b.

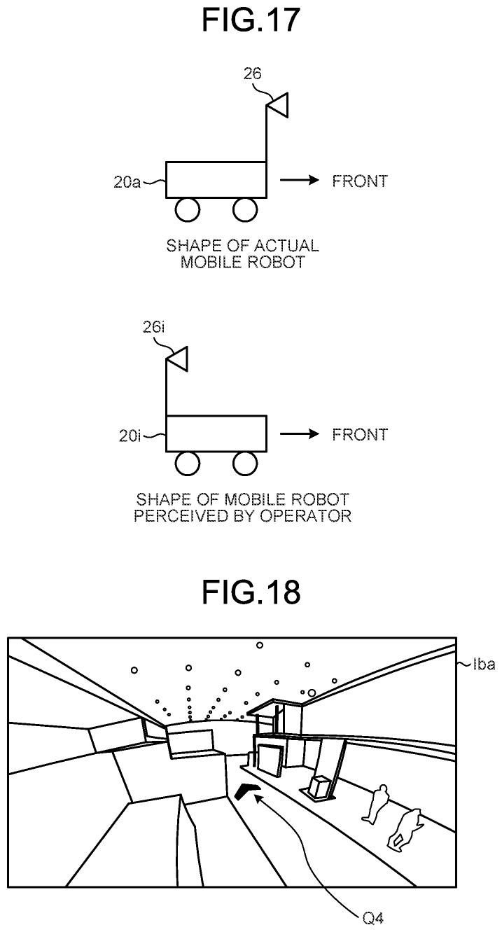

FIG. 17 is a diagram explaining a camera installation position of a mobile robot. As illustrated in FIG. 17, for example, the camera 26 is installed in front of the mobile robot 20a, but the camera 26 may be virtually installed behind the mobile robot 20a to show a part of the shape of the mobile robot 20a by AR (for example, FIG. 16). That is, the operator 50 perceives that a mobile robot 20i behind which a camera 26i is installed is being operated. Thus, the distance in the traveling direction can be gained by a difference between the position of the actual camera 26 and the position of the virtual camera 26i.

That is, when the position of the virtual camera 26i is set behind the mobile robot 20i and the surrounding environment at the current position of the mobile robot 20a is reconstructed, the image Ib (second image) can be generated on the basis of the image actually captured by the camera 26 with respect to the area obtained by offsetting the camera 26i from the front to the rear of the mobile robot 20a.

Further, in a case where an image is displayed on the spherical screen 86 described in the second embodiment, since the viewpoint position of the camera can be set to the rear side, it is possible to prevent the resolution of the image Ib (second image) from deteriorating as described above.

[5-2. Presence of Unpredictable Object]

In each of the embodiments described above, delay compensation can be performed by predicting the self-positions of the mobile robots 20a and 20b. However, for example, in a case where there is a person (moving object) approaching the robot, delay compensation cannot be performed by predicting the motion of the person.

Since the mobile robots 20a and 20b perform control to avoid an obstacle using a sensor such as the LIDAR described above, it is assumed that no actual collision occurs. However, since there is a possibility that a person extremely approaches the mobile robots 20a and 20b, the operator 50 may feel uneasiness about the operation. In such a case, for example, the moving speed of the person may be individually predicted, and a prediction image corresponding to the mobile robots 20a and 20b may be presented, so that a video with a sense of security may be presented to the operator 50. Specifically, the prediction image is generated on the assumption that the relative speed of the person (moving object) is constant.

(6. Description of Specific Application Example of Information Processing Apparatus)

Next, an example of a specific information processing system to which the present disclosure is applied will be described. Note that any of the above-described embodiments that realizes delay compensation of an image can be applied to the system described below.

[6-1. Description of Fourth Embodiment to Which the Present Disclosure is Applied]

FIG. 18 is a diagram explaining an outline of a fourth embodiment. The fourth embodiment is an example of an information processing system in a case where a mobile robot is a flight apparatus. More specifically, it is a system in which a camera is installed in a flight apparatus represented by a drone, and an operator at a remote location monitors an image captured by the camera while flying the flight apparatus. That is, the flight apparatus is an example of the mobile body of the present disclosure.

FIG. 18 illustrates an example of an image Iba (an example of the second image) monitored by the operator. The image Iba is an image generated by the method described in the third embodiment. That is, the image Iba corresponds to the image J3 in FIG. 1. An icon Q4 indicating the flight apparatus itself is displayed in the image Iba. Since the image Iba is an image viewed from an objective viewpoint, display delay compensation is performed.

The operator maneuvers the flight apparatus while monitoring the image Iba to monitor the flight environment or the like. Since the image Iba is subjected to display delay compensation, the operator can unfailingly maneuver the flight apparatus. Note that the drone calculates the self-position (latitude and longitude) using, for example, a GPS receiver.

[6-2. Description of Fifth Embodiment to Which the Present Disclosure is Applied]

FIG. 19 is a diagram explaining an outline of a fifth embodiment. The fifth embodiment is an example in which the present disclosure is applied to an information processing system that performs work by remotely operating a robot arm, an excavator, or the like. More specifically, in FIG. 19, the current position of the robot arm is displayed by AR as icons Q5 and Q6 in an image Ibb (an example of the second image) captured by the camera installed in the robot arm. That is, the image Ibb corresponds to the image J3 of FIG. 1.

As described above, by displaying a distal end portion of the robot arm by AR, the current position of the robot arm can be transmitted to the operator without delay, and workability can be improved.

[6-3. Description of Sixth Embodiment to Which the Present Disclosure is Applied]

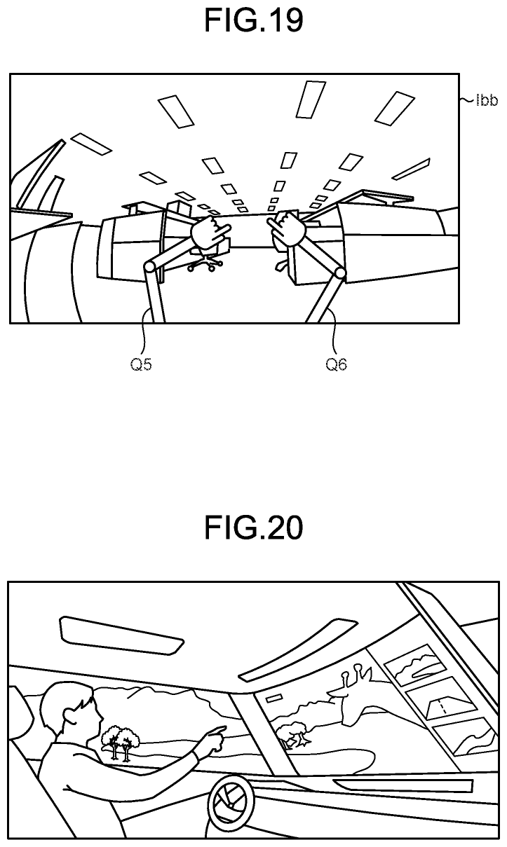

FIG. 20 is a diagram explaining an outline of a sixth embodiment. The sixth embodiment is an example in which the present disclosure is applied to monitoring of an out-of-vehicle situation of a self-driving vehicle. Note that the self-driving vehicle according to the present embodiment calculates a self-position (latitude and longitude) using, for example, a GPS receiver and transmits the self-position to the information processing apparatus.

In the self-driving vehicle, since the driving operation can be entrusted to the vehicle, it is sufficient if the occupant monitors the external situation with a display installed in the vehicle. At that time, when a delay occurs in the monitored image, for example, the inter-vehicle distance from the vehicle ahead is displayed closer than the actual distance, which may increase the sense of uneasiness of the occupant. Further, there is a possibility that carsickness is induced by a difference generated between the acceleration feeling actually felt and the movement of the image displayed on the display.

FIG. 20 solves such a problem, and performs delay compensation of an image displayed in the vehicle by applying the technology of the present disclosure.

As described in the first embodiment, according to the present disclosure, since the viewpoint position of the camera can be freely changed, for example, by setting the position of the virtual camera behind the ego vehicle position, it is possible to present an image farther than the actual inter-vehicle distance, that is, an image with a sense of security. Further, according to the present disclosure, delay compensation of an image to be displayed can be performed, so that it is possible to eliminate a difference between the acceleration feeling actually felt and the movement of the image displayed on the display. Thus, it is possible to prevent induced carsickness.

[6-4. Description of Seventh Embodiment to Which the Present Disclosure is Applied]

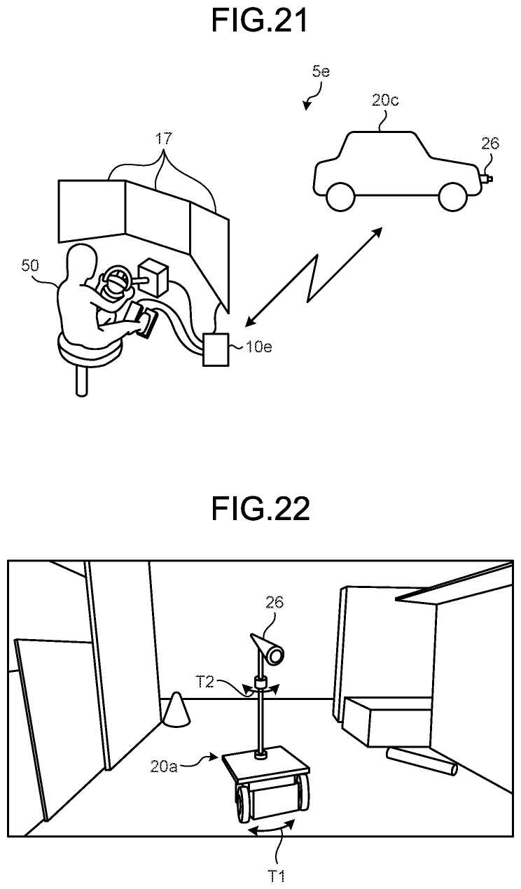

FIG. 21 is a diagram explaining an outline of a seventh embodiment. The seventh embodiment is an example in which the present disclosure is applied to a remote operation system 5e (an example of the information processing system) that remotely maneuvers a vehicle 20c (an example of the mobile body). An information processing apparatus 10e is installed at a position away from the vehicle, and the operator 50 displays, on a display 17, an image captured by the camera 26 included in the vehicle 20c and received by the information processing apparatus 10e. Then, the operator 50 remotely maneuvers the vehicle 20c while viewing the image displayed on the display 17. At this time, the operator 50 operates a steering apparatus and an accelerator/brake configured similarly to the vehicle 20c while viewing the image displayed on the display 17. The operation information of the operator 50 is transmitted to the vehicle 20c via the information processing apparatus 10e, and the vehicle 20c is controlled according to the operation information instructed by the operator 50. Note that the vehicle according to the present embodiment calculates a self-position (latitude and longitude) using, for example, a GPS receiver and transmits the self-position to the information processing apparatus 10e.

In particular, the information processing apparatus 10e performs the delay compensation described in the first embodiment to the third embodiment with respect to the image captured by the camera 26 and displays the image on the display 17. Thus, since the operator 50 can view an image without delay, the vehicle 20c can be remotely maneuvered safely without delay.

[6-5. Description of Eighth Embodiment to Which the Present Disclosure is Applied]

FIG. 22 is a diagram explaining an outline of an eighth embodiment. The eighth embodiment is an example in which the mobile robot 20a is provided with a changing swing mechanism capable of moving the orientation of the camera 26 in the direction of arrow T1. In the present embodiment, the camera 26 transmits information indicating its own imaging direction to the information processing apparatus. Then, the information processing apparatus receives the information of the orientation of the camera 26 and uses the information for generation of the prediction image as described above.

In a case where a person is present near the mobile robot 20a, when the mobile robot 20a suddenly changes the course when changing the course in the direction of arrow T2 in order to avoid the person, such change becomes behavior that causes anxiety for the person (the person does not know when the mobile robot 20a turns). Therefore, when the course is changed, the camera first moves in the direction of arrow T1 so as to face the direction to which the course is changed, and then the main body of the mobile robot 20a changes the course in the direction of arrow T2. Thus, the mobile robot 20a can move in consideration of surrounding people.

Further, similarly, when the mobile robot 20a starts moving, that is, when the mobile robot 20a starts traveling, the mobile robot 20a can start traveling after causing the camera 26 to swing.

However, by causing the operator of the mobile robot 20a to perform such a swing operation, a delay occurs until the mobile robot 20a actually starts a course change or traveling in response to the operator's course change instruction or traveling instruction. The delay occurring in such a case may be compensated by the present disclosure. Note that when the mobile robot 20a starts moving after the operator's input, there is a possibility that the mobile robot 20a collides with an object around the mobile robot 20a. However, as described in the variation of the first embodiment, when the mobile robot 20a is provided with a distance measuring function such as LIDAR, because the mobile robot 20a can autonomously move on the basis of the output of the distance measuring function, such collision can be avoided.

Note that the effects described in the present specification are merely examples and are not limitative, and there may be other effects. Further, the embodiment of the present disclosure is not limited to the above-described embodiments, and various modifications can be made without departing from the gist of the present disclosure.

Note that the present disclosure can also have the configurations described below.

(1)

An information processing apparatus comprising:

a mobile body information reception unit configured to receive mobile body information including a first image captured by an imaging unit mounted on a mobile body;

an operation information generation unit configured to generate operation information including movement control information for instructing the mobile body to move on a basis of an input to an operation input unit;

an operation information transmission unit configured to transmit the operation information including the movement control information to the mobile body; and

an image generation unit configured to generate a second image corresponding to movement of the mobile body indicated by the movement control information from the first image on a basis of the movement control information.

(2)

The information processing apparatus according to (1), wherein

the movement control information includes a moving direction and a moving amount of the mobile body.
(3)

The information processing apparatus according to (1) or (2), wherein

the mobile body information received by the mobile body information reception unit further includes position information indicating a position of the mobile body at a time when the first image is captured, and

the information processing apparatus further comprises a current position estimation unit configured to estimate a current position of the mobile body at the time on a basis of the position information and the operation information transmitted by the operation information transmission unit.

(4)

The information processing apparatus according to (3), wherein

the image generation unit generates the second image corresponding to the current position estimated by the current position estimation unit from the first image.

(5)

The information processing apparatus according to any one of (1) to (4), further comprising:

a display control unit configured to cause a display unit to display the second image.

(6)

The information processing apparatus according to any one of (1) to (5), wherein

the second image includes an image predicted to be captured from a viewpoint position of the imaging unit corresponding to a current position of the mobile body.

(7)

The information processing apparatus according to any one of (3) to (6), wherein

the current position estimation unit estimates the current position of the mobile body by adding a moving direction and a moving amount of the mobile body according to the operation information transmitted by the operation information transmission unit from time before current time to the current time to a position of the mobile body indicated by the position information received by the mobile body information reception unit at the time before the current time.

(8)

The information processing apparatus according to any one of (3) to (7), further comprising:

a destination instruction unit configured to instruct a destination of the mobile body,

wherein the image generation unit generates an image in which a direction of the destination is viewed from the current position of the mobile body from the first image on a basis of the current position of the mobile body estimated by the current position estimation unit, the position of the mobile body at the time when the first image is captured, and a position of the destination.

(9)

The information processing apparatus according to any one of (3) to (8), wherein

the second image includes an image having a video effect of causing an illusion of a position change of the mobile body according to the position of the mobile body at the time when the first image is captured and the current position of the mobile body estimated by the current position estimation unit.

(10)

The information processing apparatus according to (9), wherein

the second image is generated by projecting the first image onto a curved surface deformed according to a difference between the position of the mobile body at the time when the first image is captured and the current position of the mobile body estimated by the current position estimation unit.

The information processing apparatus according to (10), wherein

the curved surface is a spherical surface installed so as to surround the imaging unit.
(12)

The information processing apparatus according to any one of (9) to (11), wherein

the second image includes an image in which a VECTION effect is applied to the first image.

(13)

The information processing apparatus according to any one of (1) to (12), wherein

the image generation unit superimposes a part or whole of the mobile body in the first image.

(14)

The information processing apparatus according to any one of (1) to (13), wherein

the image generation unit superimposes information representing a part or whole of the mobile body on the current position of the mobile body estimated by the current position estimation unit in the first image.

(15)

The information processing apparatus according to (14), wherein

the information includes an icon imitating the mobile body.

(16)

The information processing apparatus according to any one of (1) to (15), wherein

the display control unit displays the second image on a head mounted display.

(17)

An information processing method comprising:

a mobile body information reception process of receiving mobile body information including a first image captured by an imaging unit mounted on a mobile body;

an operation information generation process of generating operation information including movement control information for instructing the mobile body to move on a basis of an operation input;

an operation information transmission process of transmitting the operation information including the movement control information to the mobile body; and

an image generation process of generating a second image corresponding to movement of the mobile body indicated by the movement control information from the first image on a basis of the movement control information.

(18)

A program for causing a computer to function as:

a mobile body information reception unit configured to receive mobile body information including a first image captured by an imaging unit mounted on a mobile body;

an operation information generation unit configured to generate operation information including movement control information for instructing the mobile body to move on a basis of an input to an operation input unit;

an operation information transmission unit configured to transmit the operation information including the movement control information to the mobile body; and

an image generation unit configured to generate a second image corresponding to movement of the mobile body indicated by the movement control information from the first image on a basis of the movement control information.

### REFERENCE SIGNS LIST

5a, 5b, 5c, 5d INFORMATION PROCESSING SYSTEM

5e REMOTE OPERATION SYSTEM (INFORMATION PROCESSING SYSTEM)

10a, 10b, 10c, 10d, 10e INFORMATION PROCESSING APPARATUS

14 OPERATION INPUT COMPONENT

16 HMD (DISPLAY UNIT)

20a, 20b MOBILE ROBOT (MOBILE BODY)

20c VEHICLE (MOBILE BODY)

26 CAMERA (IMAGING UNIT)

50 OPERATOR

70 MOBILE BODY INFORMATION RECEPTION UNIT

70a IMAGE ACQUISITION UNIT

70b POSITION ACQUISITION UNIT

73 CURRENT POSITION ESTIMATION UNIT

73a, 73b, 73c, 73d IMAGE GENERATION UNIT

74 DISPLAY CONTROL UNIT

75 OPERATION INFORMATION GENERATION UNIT

76 OPERATION INFORMATION TRANSMISSION UNIT

77 DESTINATION INSTRUCTION UNIT

79 OPERATION INPUT UNIT

80 AUDIO-VISUAL INFORMATION ACQUISITION UNIT

81 SENSOR UNIT

82 SELF-POSITION ESTIMATION UNIT

83 ACTUATION UNIT

84 MOBILE BODY INFORMATION TRANSMISSION UNIT

85 OPERATION INFORMATION RECEPTION UNIT

g SCALE VARIABLE

Ia IMAGE (FIRST IMAGE)

Ib, Ib1, Ib2, Ib3, Ib4, Ib5, Ib6, Ib7, Ib8, Ib9, Iba, Ibb IMAGE (SECOND IMAGE)

P(t) CURRENT POSITION

Pe(t) PREDICTED POSITION DIFFERENCE

Q1, Q2, Q3, Q4, Q5, Q6 ICON

R VIRTUAL ROBOT (AR ROBOT)

1. An information processing apparatus comprising:
a mobile body information reception unit configured to receive mobile body information including a first image captured by an imaging unit mounted on a mobile body;
an operation information generation unit configured to generate operation information including movement control information for instructing the mobile body to move on a basis of an input to an operation input unit;
an operation information transmission unit configured to transmit the operation information including the movement control information to the mobile body; and
an image generation unit configured to generate a second image corresponding to movement of the mobile body indicated by the movement control information from the first image on a basis of the movement control information.

2. The information processing apparatus according to claim 1, wherein
the movement control information includes a moving direction and a moving amount of the mobile body.

3. The information processing apparatus according to claim 1, wherein
the mobile body information received by the mobile body information reception unit further includes position information indicating a position of the mobile body at a time when the first image is captured, and
the information processing apparatus further comprises a current position estimation unit configured to estimate a current position of the mobile body at the time on a basis of the position information and the operation information transmitted by the operation information transmission unit.

4. The information processing apparatus according to claim 3, wherein
the image generation unit generates the second image corresponding to the current position estimated by the current position estimation unit from the first image.

5. The information processing apparatus according to claim 1, further comprising:
a display control unit configured to cause a display unit to display the second image.

6. The information processing apparatus according to claim 1, wherein
the second image includes an image predicted to be captured from a viewpoint position of the imaging unit corresponding to a current position of the mobile body.

7. The information processing apparatus according to claim 3, wherein
the current position estimation unit estimates the current position of the mobile body by adding a moving direction and a moving amount of the mobile body according to the operation information transmitted by the operation information transmission unit from time before current time to the current time to a position of the mobile body indicated by the position information received by the mobile body information reception unit at the time before the current time.

8. The information processing apparatus according to claim 3, further comprising:
a destination instruction unit configured to instruct a destination of the mobile body,
wherein the image generation unit generates an image in which a direction of the destination is viewed from the current position of the mobile body from the first image on a basis of the current position of the mobile body estimated by the current position estimation unit, the position of the mobile body at the time when the first image is captured, and a position of the destination.

9. The information processing apparatus according to claim 3, wherein
the second image includes an image having a video effect of causing an illusion of a position change of the mobile body according to the position of the mobile body at the time when the first image is captured and the current position of the mobile body estimated by the current position estimation unit.

10. The information processing apparatus according to claim 9, wherein
the second image is generated by projecting the first image onto a curved surface deformed according to a difference between the position of the mobile body at the time when the first image is captured and the current position of the mobile body estimated by the current position estimation unit.

11. The information processing apparatus according to claim 10, wherein
the curved surface is a spherical surface installed so as to surround the imaging unit.

12. The information processing apparatus according to claim 9, wherein
the second image includes an image in which a VECTION effect is applied to the first image.

13. The information processing apparatus according to claim 1, wherein
the image generation unit superimposes a part or whole of the mobile body in the first image.

14. The information processing apparatus according to claim 3, wherein
the image generation unit superimposes information representing a part or whole of the mobile body on the current position of the mobile body estimated by the current position estimation unit in the first image.

15. The information processing apparatus according to claim 14, wherein
the information includes an icon imitating the mobile body.

16. The information processing apparatus according to claim 5, wherein
the display control unit displays the second image on a head mounted display.

17. An information processing method comprising:
a mobile body information reception process of receiving mobile body information including a first image captured by an imaging unit mounted on a mobile body;
an operation information generation process of generating operation information including movement control information for instructing the mobile body to move on a basis of an operation input;
an operation information transmission process of transmitting the operation information including the movement control information to the mobile body; and
an image generation process of generating a second image corresponding to movement of the mobile body indicated by the movement control information from the first image on a basis of the movement control information.

18. A program for causing a computer to function as:
a mobile body information reception unit configured to receive mobile body information including a first image captured by an imaging unit mounted on a mobile body;
an operation information generation unit configured to generate operation information including movement control information for instructing the mobile body to move on a basis of an input to an operation input unit;
an operation information transmission unit configured to transmit the operation information including the movement control information to the mobile body; and
an image generation unit configured to generate a second image corresponding to movement of the mobile body indicated by the movement control information from the first image on a basis of the movement control information.
